(19) United States
(12) Patent Application Publication
(10) Pub. No.: US 2004/0062947 A1
(43) Pub. Date: Apr. 1, 2004

(54) Organic electroluminescent compositions

(76) Inventors: Sergey A. Lamansky, Apple Valley, MN (US); John P. Baetzold, North Saint Paul, MN (US); Fred B. McCormick, Maplewood, MN (US); Manoj Nirmal, Saint Paul, MN (US); Ralph R. Roberts, Cottage Grove, MN (US)

Correspondence Address: 3M INNOVATIVE PROPERTIES COMPANY, PO BOX 33427, ST. PAUL, MN, 55133-3427, US

(21) Appl. No.: 10/254,237

(22) Filed: Sep. 25, 2002

(51) Int. Cl. H05B 33/14; C09K 11/06

(52) U.S. Cl. 428/690; 428/917; 313/504; 252/301.16; 252/301.35

(57) ABSTRACT

Organic electroluminescent compositions comprise

(a) a charge transport matrix comprising at least one electron transport material;

(b) at least one non-polymeric emissive dopant; and

(c) at least one tertiary aromatic amine selected from the group consisting of

(1) tertiary aromatic amines wherein at least one of the organic groups comprises a substituted phenyl group having an electron-donating substituent in the para-position or two independently selected electron-donating substituents in the meta-positions,

(2) tertiary aromatic amines wherein at least two of the organic groups each comprise an independently selected substituted biphenyl or substituted fluorenyl group having an electron-donating substituent in the para-position of its terminal phenyl ring, and

(3) tertiary aromatic amines wherein at least one of the organic groups comprises a fused polyaromatic group and at least one other organic group comprises a substituted biphenyl or substituted fluorenyl group having an electron-donating substituent in the para-position of its terminal phenyl ring.

### FIELD

This invention relates to organic electroluminescent compositions that are useful in organic light-emitting diodes and, in other aspects, to devices, articles, and thermal transfer donor sheets comprising the compositions. In still another aspect, this invention relates to methods for making devices comprising the compositions.

### BACKGROUND

Organic electroluminescent devices such as organic light-emitting diodes (OLEDs), which use organic materials to generate light, are an attractive alternative to traditional display technologies (for example, liquid crystal displays (LCDS) and cathode ray tubes (CRTs)) for many display applications. OLED technology can provide various advantages over LCDs and CRTs such as, for example, increased brightness, lighter weight, thinner profile, broader operating range, better power efficiency, fuller viewing angles, and self-luminescence.

OLED devices can be divided into three classes: small molecule devices, light-emitting polymer (LEP) devices, and molecularly doped polymer/molecular film (MDP/MF) devices. Small molecule devices typically comprise a number of functional organic layers incorporating relatively low molecular weight charge transport materials and emissive dopants. LEP devices comprise light-emitting conjugated polymers as electroluminescent chromophores, which also typically perform most or all of the device's charge transport functions. MDP/MF devices typically comprise a charge transport matrix (which, in the case of MDPs, comprises at least one polymeric material) and non-polymeric emissive dopants.

Most commercially available OLED displays being made today are small molecule displays. Small molecule devices are typically fabricated using vacuum evaporation techniques. The size of vacuum chambers, as well as shadow mask size and resolution, can limit the size of small molecule displays. In comparison, LEP and MDP/MF devices can be fabricated, without masking techniques, to high resolution and large area by solution processing. Thus, LEP and MDP/MF displays can potentially be large, and possibly flexible.

Typically, MDP/MF devices offer greater color tunability than LEP devices due to the relative ease of incorporating various luminescent dopants into the MDP/MF. Nevertheless, MDP/MF devices have received less commercial attention than the other classes of OLED devices since both small molecule and LEP devices have demonstrated lower turn-on and operation voltages and significantly longer operational lifetimes (for example, the time required to reach half of the initial luminance at a given constant current) than MDP/MF devices. MDP/MF OLEDs have typically shown relatively high operation voltages and very low operation lifetimes, typically ranging from approximately one to less than about 100 hours. (See, for example, Wu et al., Applied Physics Letters, 70, 1348 (1997) reporting MDP device lifetimes of approximately 20-40 hours and turn-on voltages of 8-11 V; and Chang et al., Applied Physics Letters, 79, 2088 (2001) reporting MDP device lifetimes of approximately 40 hours.)

### SUMMARY

In view of the foregoing, we recognize that there is a need for organic electroluminescent compositions that can be used to provide organic electroluminescent MDP/MF devices with improved operational lifetimes and that operate at decreased voltages.

Briefly, in one aspect, the present invention provides organic electroluminescent compositions that are useful in electroluminescent devices such as, for example, OLEDs. The compositions comprise

(a) a charge transport matrix comprising at least one electron transport material;

(b) at least one non-polymeric emissive dopant; and

(c) at least one tertiary aromatic amine comprising three organic groups directly bonded to nitrogen, the tertiary aromatic amine being selected from the group consisting of

(1) tertiary aromatic amines wherein at least one of the organic groups comprises a substituted phenyl group having an electron-donating substituent in the para-position (relative to the direct bond to nitrogen) or two independently selected electron-donating substituents in the meta-positions (relative to the direct bond to nitrogen), each electron-donating substituent being a substituent other than a heterocyclic substituent directly bonded to the phenyl group by one of its heteroatoms,

(2) tertiary aromatic amines wherein at least two of the organic groups each comprise an independently selected substituted biphenyl or substituted fluorenyl group having an electron-donating substituent in the para-position (relative to the carbon-carbon bond connecting the two phenyl rings of the biphenyl or fluorenyl group) of its terminal phenyl ring (that is, the phenyl ring not directly bonded to nitrogen), and

(3) tertiary aromatic amines wherein at least one of the organic groups comprises a fused polyaromatic group and at least one other organic group comprises a substituted biphenyl or substituted fluorenyl group having an electron-donating substituent in the para-position (relative to the carbon-carbon bond connecting the two phenyl rings of the biphenyl or fluorenyl group) of its terminal phenyl ring (that is, the phenyl ring not directly bonded to nitrogen);

the tertiary aromatic amines of categories (1), (2), and (3) being optionally further substituted, but only with electron-donating substituents;

with the proviso that when the charge transport matrix consists essentially of an electron transport material that is non-polymeric, the tertiary aromatic amine is selected from amines other than non-polymeric amines of category (3); and

with the further proviso that when the charge transport matrix contains a polyimide, the charge transport matrix comprises a second polymeric material other than a polyimide.

It has been discovered that the above-described organic electroluminescent compositions can be used to fabricate highly efficient and operationally stable MDP/MF OLEDs having lifetimes of up to 1,000 hours or more. These OLEDs operate at lower operation voltages than previously reported MDP/MF OLEDs. In fact, many OLEDs comprising the compositions of the invention satisfy the current operation voltage and efficiency requirements for various commercial display and lighting applications while showing dramatically improved operation lifetimes. Thus, the compositions of the invention meet the need in the art for electroluminescent compositions that can be used to provide organic electroluminescent MDP/MF devices with improved operational lifetimes while operating at relatively low voltages.

Additionally, it has been discovered that the organic electroluminescent compositions of the invention are not only solution processible but are also thermally printable and can be patterned onto a substrate or receptor layer using thermal patterning to fabricate, for example, emissive displays. Additional components are often necessary for good thermal transfer of LEPs. These components, however, sometimes interfere with the electrical properties of the LEP. The compositions of the invention are well suited for thermal transfer without additional components. The thermally patterned MDP/MF devices comprising the compositions of the invention demonstrate performances comparable to those of devices prepared using conventional spin coating techniques.

In other aspects, this invention also provides organic electroluminescent devices comprising compositions of the invention such as, for example OLEDs, and articles comprising the organic electroluminescent devices such as, for example, displays.

In still another aspect, this invention provides a method for making an organic electroluminescent device comprising the step of selectively transferring an organic electroluminescent composition of the invention from a donor sheet to a receptor substrate.

In yet another aspect, this invention provides donor sheets comprising an organic electroluminescent composition of the invention that are useful in the fabrication of organic electroluminescent devices.

Definitions

As used herein:

“electron-donating substituents” describes substituents on an aromatic ring which have a negative σ Hammett substituent value as described by Leffler et al., Rates and Equilibria of Organic Reactions, J. Wiley and Sons, Inc., p. 172, New York (1963).

“polymeric” describes molecules containing 10 or more monomer-derived repeat units; and

“small molecule” or “non-polymeric” describes molecules containing no monomer-derived repeat units (non-oligomeric molecules) and molecules containing fewer than 10 monomer-derived repeat units (oligomeric molecules).

### DETAILED DESCRIPTION

The organic electroluminescent compositions of the invention include both organic electroluminescent molecular film (MF) compositions and organic electroluminescent molecularly doped polymer (MDP) compositions. In the case of MDP compositions, the compositions include at least one polymer (as a component of the charge transport matrix and/or in the form of a polymeric tertiary aromatic amine). In the case of MF compositions, the compositions do not contain a polymer, but rather only small molecule components.

The compositions of the invention include, for example, the following molecular film embodiments: (1) a MF comprising a non-polymeric emissive dopant, a small molecule tertiary aromatic amine, and a charge transport matrix comprising a small molecule hole transport material and a small molecule electron transport material; (2) a MF comprising a non-polymeric emissive dopant, a small molecule tertiary aromatic amine, and a charge transport matrix comprising an electrically inert small molecule and a small molecule electron transport material; and (3) a MF comprising a non-polymeric emissive dopant, a small molecule tertiary aromatic amine, and a charge transport matrix comprising a small molecule electron transport material.

The compositions of the invention also include the following molecularly doped polymer embodiments: (1) a MDP comprising a non-polymeric emissive dopant, a small molecule tertiary aromatic amine, and a charge transport matrix comprising a polymeric hole transport material and a small molecule electron transport material; (2) a MDP comprising a non-polymeric emissive dopant, a small molecule tertiary aromatic amine, and a charge transport matrix comprising a polymeric electron transport material; (3) a MDP comprising a non-polymeric emissive dopant, a small molecule tertiary aromatic amine, and a charge transport matrix comprising an electrically inert polymer and a small molecule electron transport material; (4) a MDP comprising a non-polymeric emissive dopant, a polymeric tertiary aromatic amine, and a charge transport matrix comprising a small molecule electron transport material; and (5) a MDP comprising a non-polymeric emissive dopant, a polymeric tertiary aromatic amine, and a charge transport matrix comprising a polymeric electron transport material.

An organic electroluminescent device can be formed by disposing a layer, or layers, of a MF or MDP compositions of the invention (the “organic layer”) between a cathode and an anode. When a potential is applied to the device, electrons are injected into the organic layer from the cathode and holes are injected into the organic layer from the anode. As the injected charges migrate toward the oppositely charged electrodes, they can recombine to form electron-hole pairs, which are typically referred to as excitons. The region of the device in which the excitons are generally formed can be referred to as the recombination zone. These excitons, or excited state species, can emit energy in the form of light as they decay back to a ground state.

Charge Transport Matrix

The organic electroluminescent compositions of the invention comprise a charge transport matrix comprising at least one electron transport material. The charge transport matrix can optionally contain other components such as, for example, hole transport materials, additional electron transport materials, electrically inert polymers or small molecules, hole injecting materials, electron injecting materials, and the like, and mixtures thereof.

Electron transport materials are materials that facilitate the injection of electrons into the organic layer and their migration toward the recombination zone. Electron transport materials can also act as a barrier for the passage of holes to the cathode, if desired.

As noted above, electron transport materials that are useful in the compositions of the invention can be either polymeric or non-polymeric (small molecules).

Useful electron transport polymers include oxadiazole-containing and triazole-containing polymers. Representative examples of useful electron transport polymers include oxadiazole-containing polyolefins (for example,

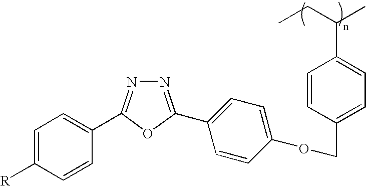

R=H (PPVO) and R=C(CH₃)₃(t-Bu) (PBVO) as described by Jiang et al. in Chem. Mater., 12, 2542 (2000)), conjugated polymers comprising oxadiazole units in the polymer backbone (for example,

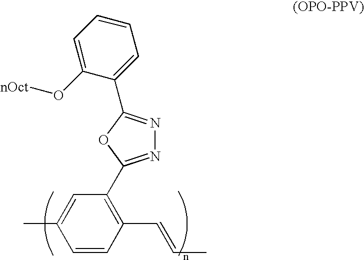

as described by Meng et al., Macromol., 32, 8841 (1999)), conjugated polymers comprising oxadiazole units pendant to the conjugated backbone (for example, copolymers of oxadiazolyl arylene and fluorene such as, for example

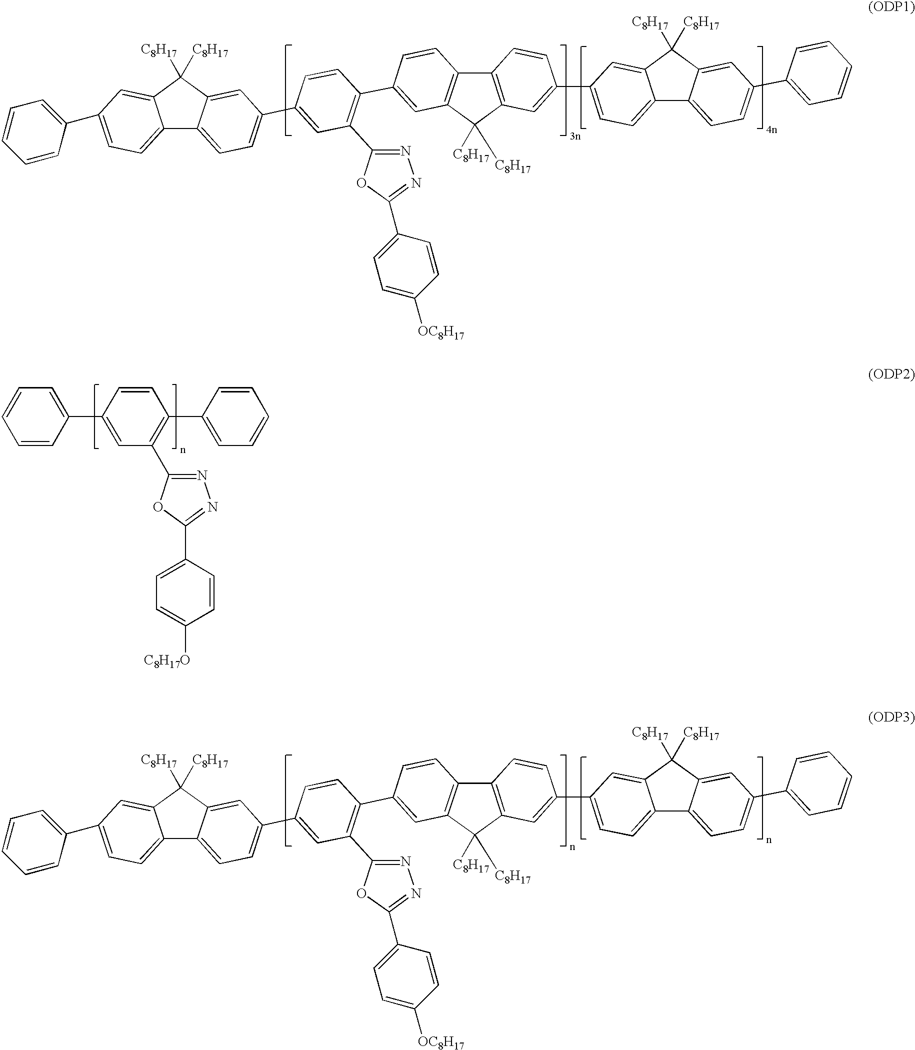

and the like, as described in U.S. patent application Ser. No. ______ entitled “Electroactive Polymers” bearing attorney docket number 57906US002 filed on even date herewith).

Preferred electron transport polymers include copolymers of oxadiazolyl arylene and fluorene such as, for example, ODP1, ODP2, and ODP3.

Representative examples of useful electron transport small molecules include oxadiazoles such as 2-(4-biphenyl)-5-(4-t-butylphenyl)-1,3,4-oxadiazole (PBD), 1,3-bis[5-(4-t-butylphenyl)-1,3,4-oxadiazol-2-yl]benzene (PBD dimer), 1,3,5-tris(5-(p-octyloxyphenyl)-1,3,4-oxadiazol-2-yl)benzene (OPOB), and 2,5-bis(1-naphthyl)-1,3,4-oxadiazole (BND), as well as starburst and dendrimeric derivatives of oxadiazoles (see, for example, Bettenbhausen et al., Synthetic Metals, 91, 223 (1997)); N-substituted triazole derivatives such as 3-(4-biphenylyl)-4-phenyl-5-(4-tert-butylphenyl)1,2,4-triazole (TAZ), as well as starburst and dendrimeric derivatives of triazoles; metal chelates such as tris(8-hydroxyquinolato) aluminum (Alq₃) and biphenylato bis(8-hydroxyquinolato)aluminum (BAlq); and other compounds described in C. H. Chen et al., Macromol. Symp., 125, 1 (1997), and J. V. Grazulevicius et al., “Charge-Transporting Polymers and Molecular Glasses,” Handbook of Advanced Electronic and Photonic Materials and Devices, H. S. Nalwa (ed.), 10, 233 (2001); and the like and mixtures thereof. Preferred electron transport small molecules include PBD, OPOB, and TAZ.

Hole transport materials are materials that facilitate the injection of holes from the anode into the organic layer and their migration toward the recombination zone. The compositions of the invention comprise at least one tertiary aromatic amine of three specified categories (described supra and, in more detail, infra), which is a hole transport material. The charge transport matrix, however, can comprise other hole transport materials, if desired.

Hole transport materials that are useful in the charge transport matrix can be either polymeric or non-polymeric (small molecules) hole transport materials having relatively high ionization potential (typically higher than about 5.4 eV).

Suitable hole transport polymers include hole transport materials such as, for example, poly(9-vinylcarbazole) (PVK), poly(9-vinylcarbazole-diphenylaminostyrene) copolymer (PVK-DPAS), and polystyrene-diphenylaminostyrene copolymer (PS-DPAS). PVK is a preferred hole transport polymer.

Suitable hole transport small molecules include, for example, diarylamine and triarylamine derivatives such as, for example, N,N′-bis(3-methylphenyl)-N,N′-bis(phenyl)benzidine (TPD), 4,4′-bis(carbazol-9-yl)biphenyl (CBP), and 4,4′,4″-tris(carbazol-9-yl)-triphenylamine (TCTA). Other examples include copper phthalocyanine (CuPC) and compounds such as those described in H. Fujikawa et al., Synthetic Metals, 91, 161 (1997) and J. V. Grazulevicius, P. Strohriegl, “Charge-Transporting Polymers and Molecular Glasses”, Handbook of Advanced Electronic and Photonic Materials and Devices, H. S. Nalwa (ed.), 10, 233-274 (2001); and the like and mixtures thereof. Preferred hole transport small molecules include TPD and TCTA.

The charge transport matrix can comprise electrically inert polymers or small molecules. “Electrically inert” materials are materials in which the gap between the material's highest occupied molecular orbital (HOMO) and lowest unoccupied molecular orbital (LUMO) is sufficiently large enough that neither electrons nor holes can be efficiently injected into the material from typical organic electroluminescent device electrode materials such as indium-tin-oxide, aluminum, calcium, and the like. Electrically inert materials typically have an ionization potential higher than about 6.0 to about 6.5 eV and electron affinity lower than about 2.0 to about 2.5 eV.

When incorporated into the charge matrix, electrically inert polymers and small molecules function primarily as binder material, doing little to assist in the transport of charge carriers. Examples of suitable electrically inert polymers include polystyrene, polyethers, polyacrylates and polymethacrylates, polycarbonates, poly(vinyl naphthalene), and the like and mixtures thereof. Examples of suitable electrically inert small molecules include anthracene, phenanthrene, and 1,2,3,4-tetraphenyl-1,3-cyclopentadiene.

If the charge transport matrix contains a polyimide, the charge transport matrix comprises a second polymeric material other than a polyimide. Preferably, the charge transport matrix does not contain polyimide (that is, preferably, the charge transport matrix contains only materials other than polyimides).

The charge transport matrix can also comprise hole injecting materials such as, for example porphyrinic compounds like copper phthalocyanine (CuPc) and zinc phthalocyanine; electron injecting materials such as, for example, alkaline metal compounds comprising at least one of Li, Rb, Cs, Na, or K (for example, alkaline metal oxides or alkaline metal salts such as Li₂O, Cs₂O, or LiAlO, or metal fluorides such as LiF, CsF), as well as SiO₂, Al₂O₃, copper phthalocyanine (CuPc); and additives such as, for example, light scattering fillers, nanoparticles (preferably with a particle size between about 10 nm and 100 nm) for inducing higher outcoupling of light and emission uniformity, cross-linking agents, tackifiers or plasticizers, and quenchers for singlet oxygen and similar reactive compounds.

Emissive Dopant

The compositions of the invention comprise at least one non-polymeric emissive dopant. Non-polymeric emissive dopants that are useful in the organic electroluminescent compositions of the invention include fluorescent and phosphorescent (preferably phosphorescent) small molecule emitters that are capable of emitting radiation within a large range of wavelengths (preferably, from about 250 nm to about 800 nm; more preferably, from about 400 nm to about 700 nm). Preferably, the non-polymeric emissive dopants have a half-life of about 10⁻⁹ seconds to about 10⁻² seconds (more preferably, about 10⁻⁹ seconds to about 10⁻⁴ seconds) and a luminescence quantum yield of about 5% to 100% (more preferably, about 50% to 100%).

Small molecule emitters useful in the invention are preferably selected from molecular emitters derived from fluorescent polynuclear carbocyclic arylene and heteroarylene derivatives, phosphorescent cyclometallated chelate complexes of Ir(III), Rh(III), Os(II), Ru(II), Ni(II) and Pt(II), and fluorescent chelate complexes of Zn(II) and Al(III).

Examples of useful fluorescent polynuclear carbocyclic arylene emitters include molecules derived from perylene, benzo[g,h,i]perylene, anthracene, pyrene, decacyclene, fluorene, and 2,5,8,11-tetra-t-butylperylene (TBP)

Examples of useful fluorescent polynuclear heteroarylene derivatives include molecules derived from coumarins such as 10-(2-benzothiazolyl)-2,3,6,7-tetrahydro1,1,7,7-tetramethyl-1H,5H,11H-[1]benzopyrano[6,7,8-i,j]quinolizin-11-one (also known as Coumarin 545T), 3-(2-benzothiazolyl)-7-diethylaminocoumarin (also known as Coumarin 6), and 3-thiophenyl-7-methoxycoumarin; and molecules derived from tricyclic pyromethene dyes such as, for example, those described in U.S. Pat. No. 4,916,711 (Boyer et al.) and U.S. Pat. No. 5,189,029 (Boyer et al.).

Examples of useful phosphorescent cyclometallated chelate complexes of Ir(III), Rh(III), Os(II), Ru(II), and Pt(II) include molecules derived from phosphorescent organometallic L¹₃Ir (III), L¹₃Rh (III), L¹L²Ir(III)X, L¹L²Rh(III)X, L¹L²Os(II)Y, L¹L²Ru(II)Y, L¹L²Pt(II) compounds where L¹ and L² can be the same or different in each instance and are optionally substituted cyclometallated bidentate ligands of 2-(1-naphthyl)benzoxazole, 2-phenylbenzoxazole, 2-phenylbenzothiazole, 2-phenylbenzimidazole, 7,8-benzoquinoline, phenylpyridine, benzothienylpyridine, 3-methoxy-2-phenylpyridine, thienylpyridine, tolylpyridine; X is selected from the group consisting of acetylacetonate (acac), hexafluoroacetylacetonate, salicylidene, picolinate, and 8-hydroxyquinolinate; and Y is selected from charge neutral chelating compounds such as optionally substituted derivatives of phenathroline or bipyridine. Useful cyclometallated Ir(III) chelate derivatives include those described in WO 0070655 and WO 0141512 A1, and useful cylcometallated Os(II) chelate derivatives include those described in U.S. patent application Ser. No. 09/935,183 filed Aug. 22, 2001. Platinum(II) porphyrins such as octaethyl porphyrin (also known as Pt(OEP)) are also useful.

Examples of useful fluorescent chelate complexes of Zn(II) and Al(III) include complexes such as bis(8-quinolinolato) zinc(II), bis(2-(2-hydroxyphenyl)benzoxazolate) zinc(II), bis(2-(2-hydroxyphenyl)benzothiazolate) zinc(II), bis(2-(2hydroxyphenyl)-5-phenyl-1,3,4-oxadiazole) zinc(II), and biphenylato bis(8-hydroxyquinolato)aluminum (BAlq). Useful fluorescent Zn (II) chelates include those described by Tokito et al., Synthetic Metals, 111-112, 393 (2000) and in WO 01/39234 A2. Useful Al(III) chelates include those described in U.S. Pat. No. 6,203,933 (Nakaya et al.).

Preferred emissive dopants include bis-(2-phenylpyridinato-N,C^{2′})iridiium(III)acetylacetonate (PPIr), bis-(2-benzo[c]thienylpyridinato-N,C^{2′})iridium(III)acetylacetonate (BTPIr), bis((4,6-difluorophenyl)pyridinato-N,C^{2′})iridium(III)picolinate (FIrpic), 2,5,8,11-tetra-t-butylperylene (TBP), 3-(2-benzothiazolyl)-7-diethylaminocoumarin (Coumarin 6), octaethyl porphyrin (PtOEP), and pyromethene 567 (Pyr567) (available from Exciton Inc., Daughton, Ohio).

Most preferred emissive dopants include phosphorescent PPIr, BTPIr, and FIrpic.

Tertiary Aromatic Amine

Tertiary aromatic amines comprise three organic groups directly bonded to a single nitrogen. A class of hole-transporting tertiary aromatic amines that is useful in compositions of the invention (hereinafter “category (1)” tertiary aromatic amines) includes tertiary aromatic amines wherein at least one of the organic groups comprises a substituted phenyl group having an electron-donating substituent in the para-position or two independently selected electron-donating substituents in the meta-positions, each electron-donating substituent being a substituent other than a heterocyclic substituent directly bonded to the phenyl group by one of its heteroatoms; the amines being optionally further substituted, but only with electron-donating substituents.

A preferred class of category (1) tertiary aromatic amines can be represented by the following general formulas:

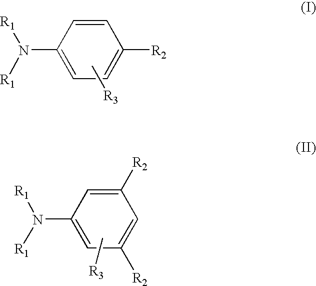

wherein each R₁ is independently selected from the group consisting of alkyl, cycloalkyl, alkenyl, cycloalkenyl, alkynyl, cycloalkynyl, aryl, heteroaryl, and combinations thereof (for example, cycloalkyl-substituted alkyl groups); each R₂ is independently selected from the group consisting of alkoxy, aryloxy, alkylthio, arylthio, dialkylamino, diarylamino, and combinations thereof (for example, alkoxy-substituted aryloxy groups); and each R₃ is independently selected from the group consisting of hydrogen, alkyl, cycloalkyl, alkenyl, cycloalkenyl, alkynyl, cycloalkynyl, aryl, and combinations thereof (for example, cycloalkyl-substituted alkyl groups).

Preferably, each R₁ is an independently selected aryl group; each R₂ is an independently selected diarylamino group; and each R₃ is independently selected from the group consisting of hydrogen and alkyl.

More preferably, each R₁ is independently selected from the group consisting of phenyl and m-tolyl; each R₂ is independently selected from the group consisting of diphenylamino, N-phenyl-N-(3-methylphenyl)amino, and di(p-t-butylphenyl)amino; and each R₃ is independently selected from the group consisting of hydrogen, methyl, n-butyl, and t-butyl.

Representative examples of category (1) tertiary aromatic amines include:

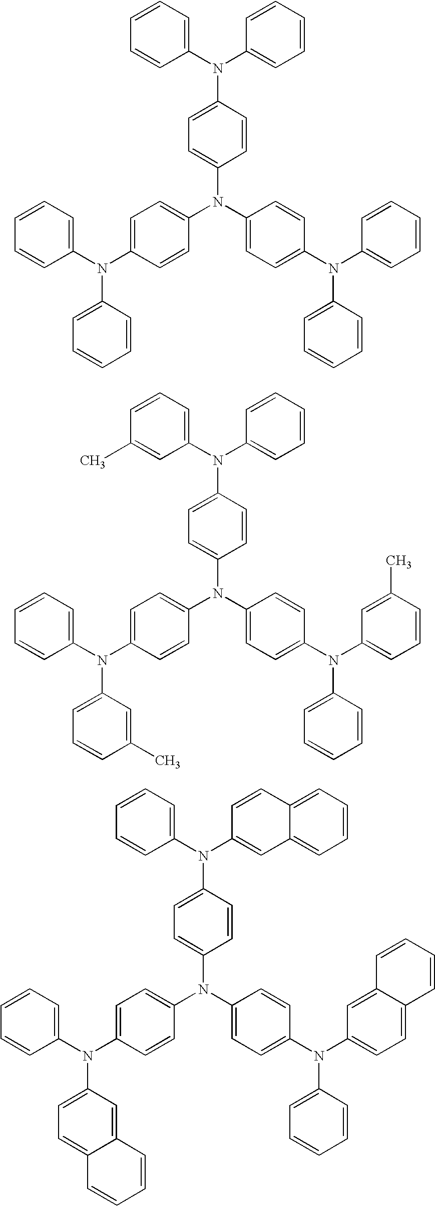

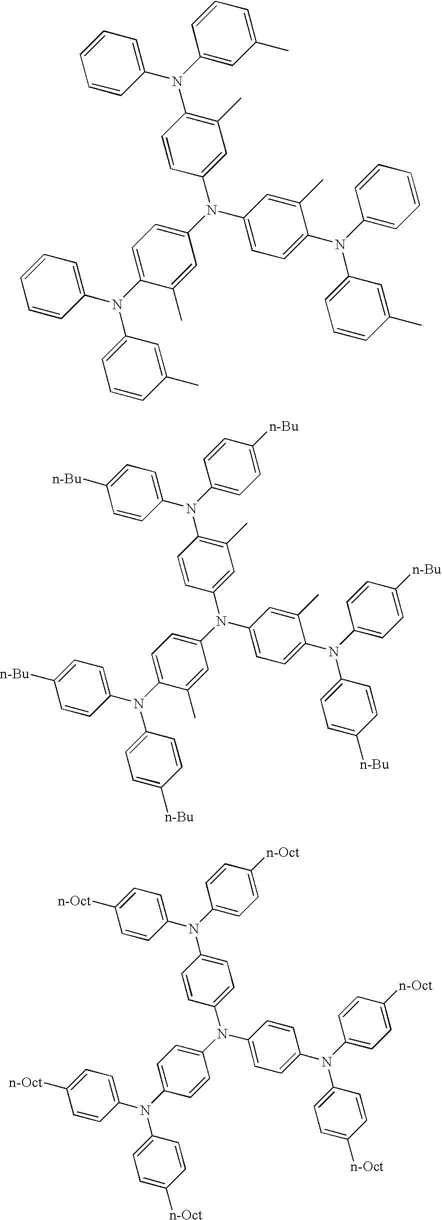

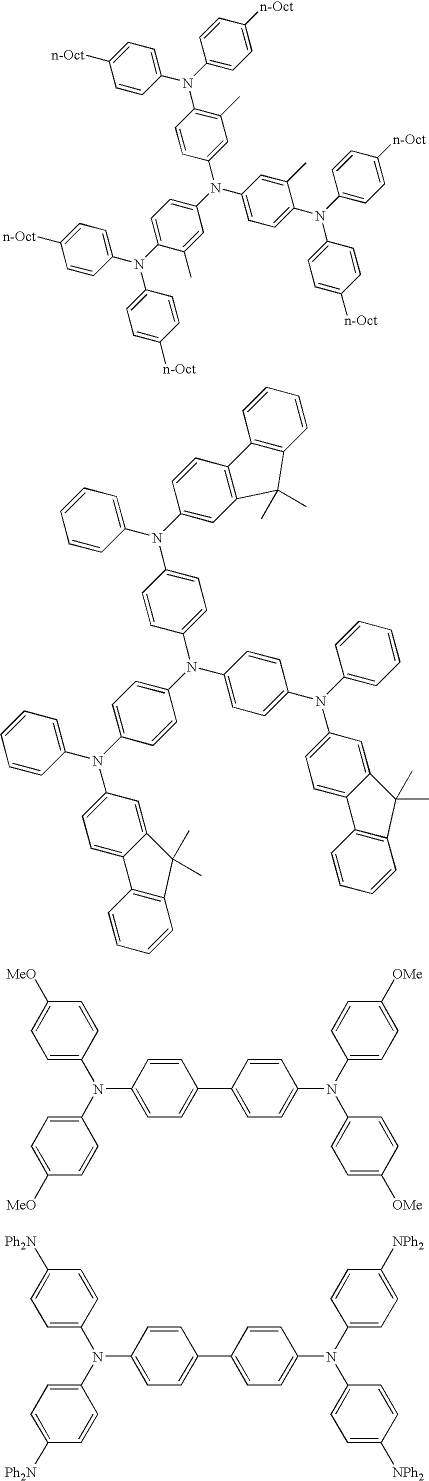

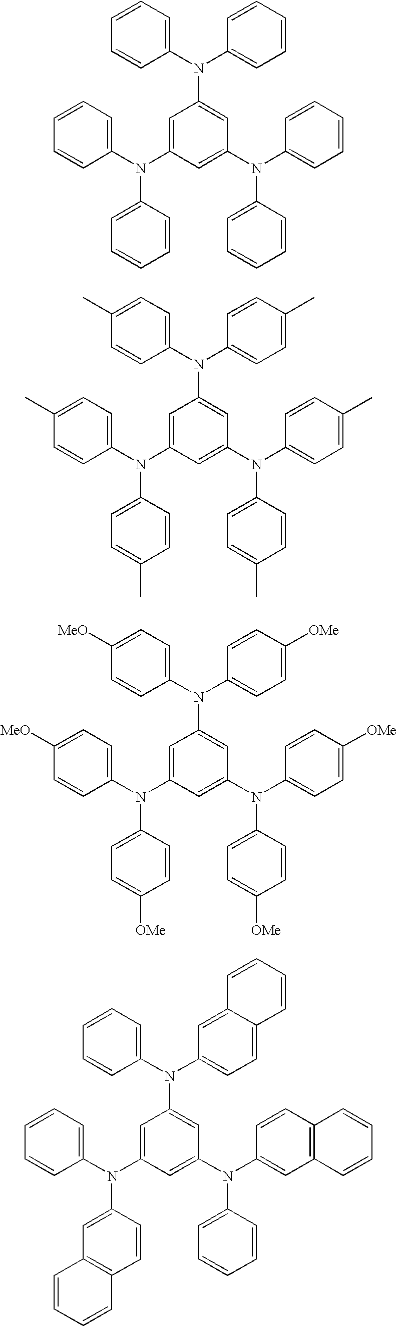

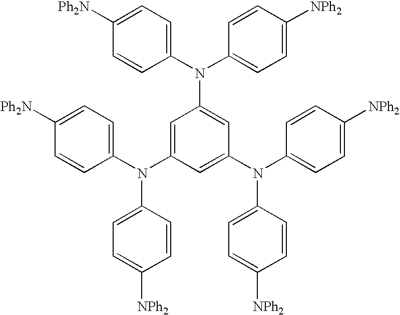

A second class of hole-transporting tertiary aromatic amines that is useful in compositions of the invention (hereinafter “category (2)” tertiary aromatic amines) includes tertiary aromatic amines wherein at least two of the organic groups each comprise an independently selected substituted biphenyl or substituted fluorenyl group having an electron-donating substituent in the para-position of its terminal phenyl ring; the amines being optionally further substituted, but only with electron-donating substituents.

A preferred class of category (2) tertiary aromatic amines can be represented by the following general formulas:

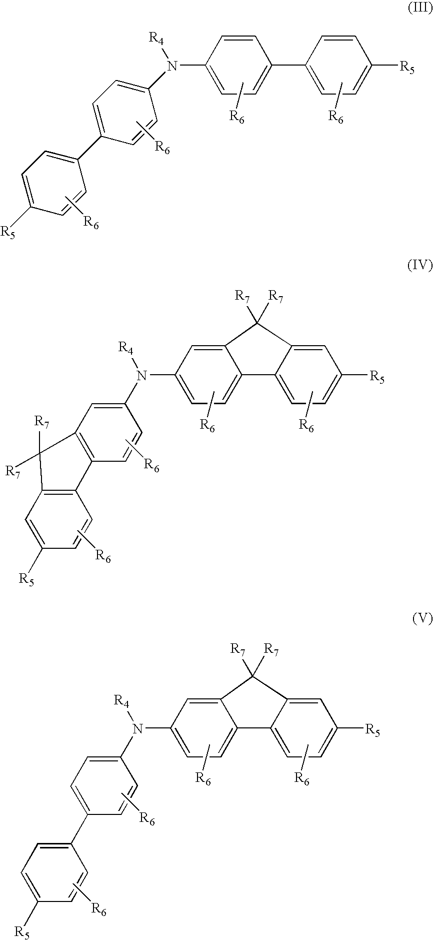

wherein each R₄ is independently selected from the group consisting of alkyl, cycloalkyl, alkenyl, cycloalkenyl, alkynyl, cycloalkynyl, aryl, heteroaryl, and combinations thereof; each R₅ is independently selected from the group consisting of alkoxy, aryloxy, alkylthio, arylthio, dialkylamino, diarylamino, and combinations thereof; each R₆ is independently selected from the group consisting of hydrogen, alkyl, cycloalkyl, alkenyl, cycloalkenyl, alkynyl, cycloalkynyl, aryl, and combinations thereof; and each R₇ is independently selected from the group consisting of hydrogen, alkyl, cycloalkyl, alkenyl, cycloalkenyl, alkynyl, cycloalkynyl, aryl, and combinations thereof.

Preferably, each R₄ is an independently selected aryl group; each R₅ is an independently selected diarylamino group; each R₆ is independently selected from the group consisting of hydrogen and alkyl; and each R₇ is independently selected from the group consisting of hydrogen and alkyl.

More preferably, each R₄ is independently selected from the group consisting of phenyl and m-tolyl; R₅ is independently selected from the group consisting of diphenylamino, N-phenyl-N-(3-methylphenyl)amino, and di(p-t-butylphenyl)amino; each R₆ is independently selected from the group consisting of hydrogen, methyl, n-butyl, and t-butyl; and each R₇ is independently selected from the group consisting of hydrogen, methyl, n-butyl, and octyl.

Representative examples of category (2) tertiary aromatic amines include:

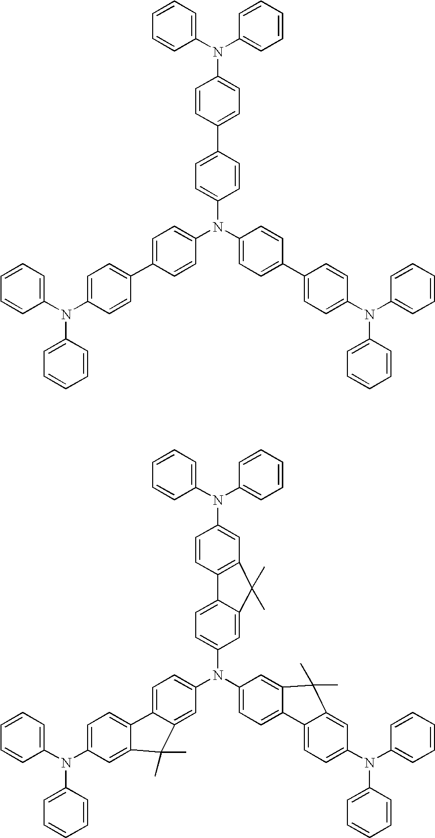

A third class of hole-transporting tertiary aromatic amines that is useful in compositions of the invention (hereinafter “category (3)” tertiary aromatic amines) includes tertiary aromatic amines wherein at least one of the organic groups comprises a fused polyaromatic group and at least one other organic group comprises a substituted biphenyl or substituted fluorenyl group having an electron-donating substituent in the para-position of its terminal phenyl ring; the amines being optionally further substituted, but only with electron-donating substituents.

A preferred class of category (3) tertiary aromatic amines can be represented by the following general formulas:

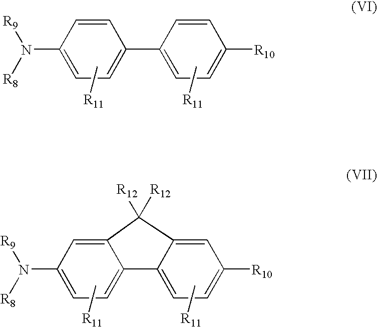

wherein each R₈ is a fused polyaromatic group; each R₉ is independently selected from the group consisting of alkyl, cycloalkyl, alkenyl, cycloalkenyl, alkynyl, cycloalkynyl, aryl, heteroaryl, fused polyaromatics, and combinations thereof; each R₁₀ is independently selected from the group consisting of alkoxy, aryloxy, alkylthio, arylthio, dialkylamino, diarylamino, and combinations thereof; each R₁₁ is independently selected from the group consisting of hydrogen, alkyl, cycloalkyl, alkenyl, cycloalkenyl, alkynyl, cycloalkynyl, aryl, heteroaryl, and combinations thereof; and each R₁₂ is independently selected from the group consisting of hydrogen, alkyl, cycloalkyl, alkenyl, cycloalkenyl, alkynyl, cycloalkynyl, aryl, heteroaryl, and combinations thereof.

Preferably, each R₈ is independently selected from the group consisting of naphthyl, anthracenyl, pyrenyl, and phenanthrenyl; each R₉ is independently selected from the group consisting of aryl and fused polyaromatics; each R₁₀ is an independently selected diarylamino group; each R₁₁ is independently selected from the group consisting of hydrogen and alkyl; and each R₁₂ is independently selected from the group consisting of hydrogen and alkyl.

More preferably, each R₈ is independently selected from the group consisting of naphthyl, anthracenyl, and phenanthrenyl; each R9 is independently selected from the group consisting of phenyl, m-tolyl, and naphthyl; each R₁₀ is independently selected from the group consisting of diphenylamino, N-phenyl-N-(2-naphthyl)amino, N-(3-methylphenyl)-N-(2-naphthyl)amino, N-phenyl-N-(3-methylphenyl)amino, and di(p-t-butylphenyl)amino; each R₁₁ is independently selected from the group consisting of hydrogen, methyl, and n-butyl; and each R₁₂ is independently selected from the group consisting of hydrogen, methyl, n-butyl, and octyl.

Representative examples of category (3) tertiary aromatic amines include:

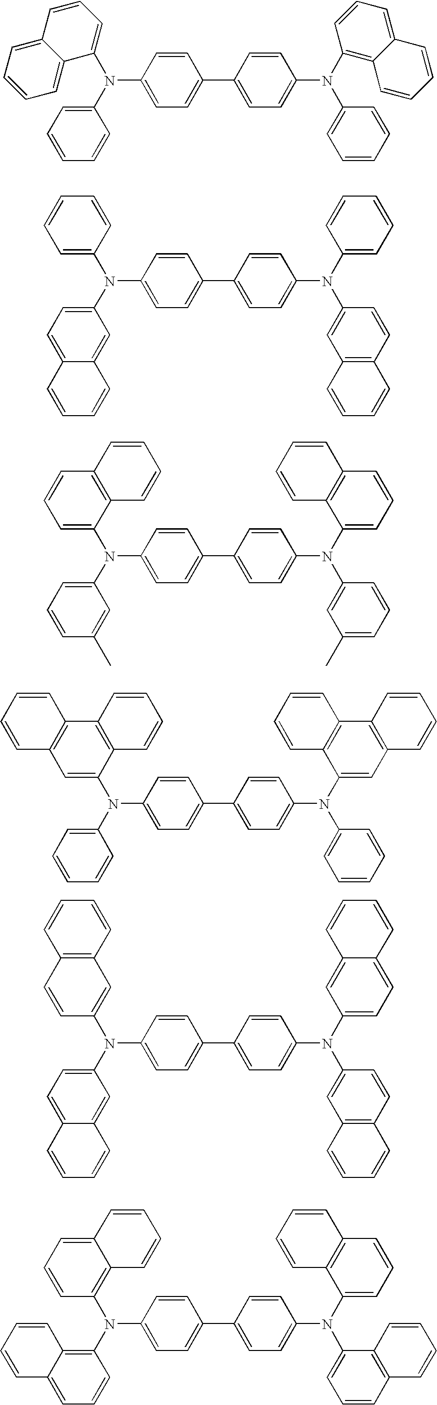

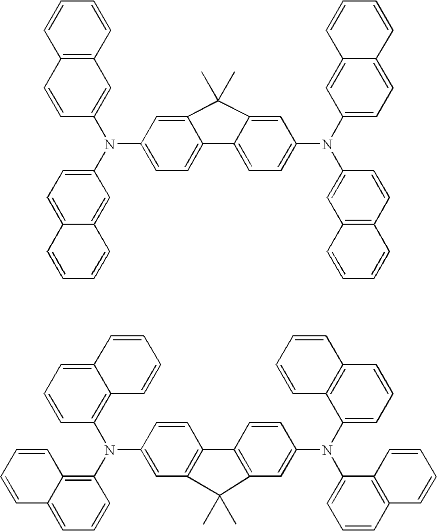

For category (1) and category (2) tertiary aromatic amines, it is most preferable that all three of the organic groups directly bonded to nitrogen are identical. For category (3) tertiary aromatic amines, it is most preferable that two of the organic groups directly bonded to nitrogen are identical fused polyaromatic groups.

Preferred tertiary aromatic amines include the following:

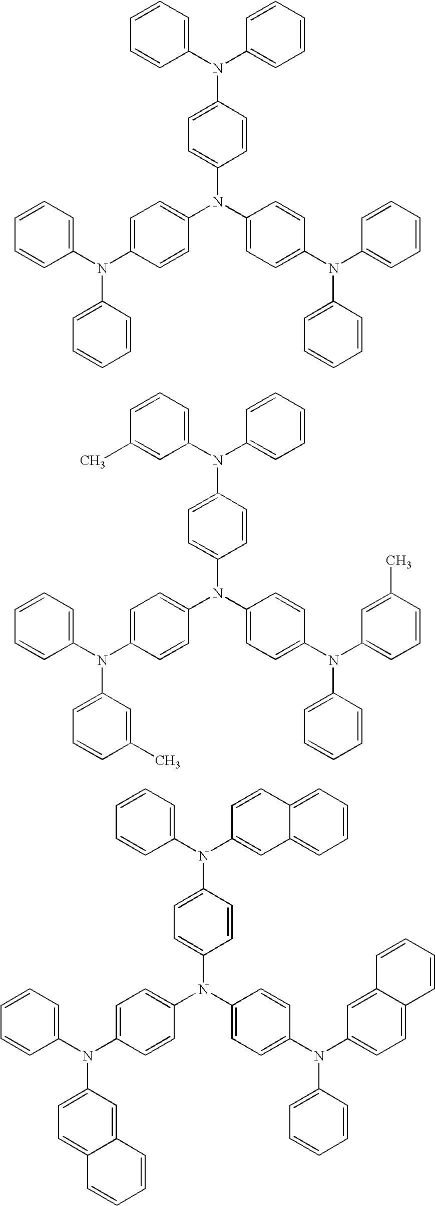

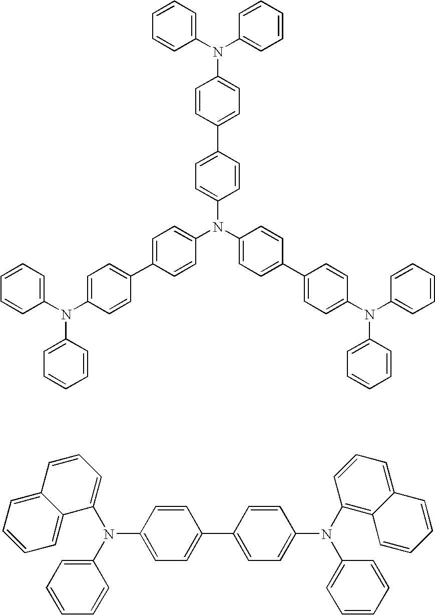

Tertiary aromatic amines useful in the organic electroluminescent compositions of the invention are hole transport agents with relatively high hole mobility (preferably greater than about 10⁻⁵ cm²/V s) and relatively low ionization potential (preferably about 4.8 eV to about 5.4 eV as estimated using indirect electrochemical redox potential measurements (for example, cyclic voltammetry) or direct photoelectron spectroscopy measurements, corresponding to relatively high HOMO (highest occupied molecular orbital) energy).

Tertiary aromatic amines useful in the invention are typically prepared by an Ulmann coupling reaction between corresponding secondary aromatic amines and arylhalides (typically aryliodides and arylbromides). Conventionally, Ulmann reactions are conducted using copper catalysts such as those described, for example, in Macromolecules, 28, 5618 (1995), but recently more efficient approaches using palladium catalysts have been developed by Hartiwig et al. (see, for example, J. Am. Chem. Soc., 119, 11695 (1997)) and Buchwald et al. (see, for example, J. Org. Chem., 61, 1133 (1996)). Also, a Suzuki-type coupling reaction between corresponding arylboronic acid and arylhalide with palladium catalysts (see, for example, Suzuki, A. in Metal Catalyzed Cross-Coupling Reactions, Diederich, F., and Stang, V. V. (ed.), Wiley-VCH, Chapter 2, Weinheim, Germany (1998)) can be employed to synthesize some tertiary aromatic amines, particularly those comprising at least one biphenyl group. A few of the tertiary aromatic amines useful in the invention are commercially available.

Preparation of Compositions

The compositions of the invention can be made by preparing a blend of the charge transport matrix, non-polymeric dopant, and tertiary aromatic amine. Typically, all the components of the compositions of the invention can be mixed together and dissolved in a solvent such as, for example, a chlorinated organic solvent (for example, chloroform, chlorobenzene, or dichlorobenzene) or an aromatic hydrocarbon solvent (for example, toluene) and then filtered using a 0.2 to 0.5 μm filter.

Generally, the compositions of the invention can contain about 0.1 to about 20 weight percent (relative to the total weight of the composition) non-polymeric emissive dopant and from about 5 to about 70 weight percent tertiary aromatic amine. The charge transport matrix makes up the remainder of the composition. Generally, the charge transport matrix can contain about 20 weight percent to about 100 weight percent (relative to all materials in the charge transport matrix) electron transport material; about 0 weight percent to about 80 weight percent additional hole transport or electrically inert materials; and about 0 weight percent to about 20 weight percent of additional components (for example, nanoparticles, cross-linking agents, tackifiers, plasticizers, quenchers, and the like).

Organic Electroluminescent Devices

The compositions of the invention can be used as the organic emitting layer in organic electroluminescent (OEL) devices such as, for example, organic light-emitting diodes (OLEDs). An OEL device generally includes one or more layers comprising one or more suitable organic materials disposed between a cathode and an anode. The organic electroluminescent compositions of this invention are particularly useful as the organic emitting layer in OEL devices because they provide a high efficiency and long operation lifetime from a solution processible and thermally printable composition.

The anode, typically made of indium-tin-oxide (ITO), is generally sputtered onto a substrate. The anode material is electrically conductive and is usually optically transparent or semi-transparent. ITO is often chosen for the anode material because it is particularly well matched to inject holes into the hole transport material HOMO (highest occupied molecular orbital) and because of its patternablity using lithographic techniques. In addition to ITO, suitable anode materials include transparent conductive oxides (TCOs) (for example, indium oxide, fluorine tin oxide (FTO), zinc oxide, vanadium oxide, zinc-tin oxide, and the like) and high work function metals (for example, gold, copper, platinum, palladium silver, and combinations thereof). In practice, the anode is optionally coated with about 10 to about 1000 Å of a conducting polymer such as compositions comprising poly(3,4-ethylenedioxythiophene) (PEDT) or polyaniline (PANI) to help planarize the surface and to modify the effective work function of the anode.

The organic emitting layer is generally disposed between the anode and a cathode. The organic electroluminescent compositions of the invention can be used as the organic emitting layer of the OEL device. The thickness of the organic emitting layer in the devices of the invention can generally range from about 20 nm to about 200 nm (preferably, from about 30 nm to about 100 nm).

The cathode is typically made of a low work function metal (for example, aluminum, barium, calcium, samarium, magnesium, silver, magnesium/silver alloys, lithium, ytterbium, or alloys of calcium and magnesium, or combinations thereof) that can inject electrons into the electron transport material LUMO (lowest unoccupied molecular orbital).

Other layers such as, for example, additional hole transport layer comprising, for example, 4,4′,4″-tris(N-(3-methylphenyl)-N-phenylamino)triphenylamine (MTDATA), N,N′-bis(naphthalene-1-yl)-N,N′-bis(phenyl) benzidine (NPD), or N,N′-bis(naphthalene-1-yl)-N,N′-bis(phenyl)benzidine (TPD); additional electron transport layers comprising tris(8-hydroxyquinolate) aluminum (III) (Alq), biphenylato bis(8-hydroxyquinolato)aluminum (BAlq), 2-(4-biphenyl)-5-(4-t-butylphenyl)-1,3,4-oxadiazole (PBD), or 3-(4-biphenylyl)-4-phenyl-5-(4-tert-butylphenyl)-1,2,4-triazole (TAZ); hole injection layers comprising, for example, porphyrinic compounds like copper phthalocyanine (CuPc) and zinc phthalocyanine; electron injection layers comprising, for example, alkaline metal oxides or alkaline metal salts; hole blocking layers comprising, for example, molecular oxadiazole and triazole derivatives (for example, 2-(4-biphenyl)-5-(4-t-butylphenyl)-1,3,4-oxadiazole (PBD), 2,9-dimethyl-4,7-diphenyl-1,10-phenanthraline (BCP), biphenylato bis(8-hydroxyquinolato)aluminum (BAlq), and 3(4-biphenylyl)-4-phenyl-5-(4-tert-butylphenyl)-1,2,4-triazole (TAZ)); electron blocking layers comprising, for example, N,N′-bis(naphthalene-1-yl)-N,N′-bis(phenyl) benzidine (NPD) and 4,4′,4″-tris(N-(3-methylphenyl)-N-phenylamino)triphenylamine (MTDATA); buffer layers; and the like can also be present in OEL devices. In addition, photoluminescent materials can be present in these layers, for example, to convert the color of light emitted by the electroluminescent material to another color. These and other such layers and materials can be used to alter or tune the electronic properties and behavior of the layered OEL device, for example, to achieve one or more features such as a desired current/voltage response, a desired device efficiency, a desired color, a desired brightness, a desired device lifetime, or a desired combination of these features.

OEL device structures comprise a layer comprising one or more OEL devices (the “device layer”) and a device substrate. Typically, the device substrate supports the device layer during manufacturing, testing, and/or use. OEL device substrates can range from rigid supports to highly flexible supports. Suitable OEL device substrates include, for example, glass, transparent plastics such as polyolefins, polyethersulfones, polycarbonates, polyesters, polyarylates, polyimides, polymeric multilayer films, and organic/inorganic composite multilayer films. Flexible rolls of glass can also be used. Such a material can be laminated to a polymer carrier for better structural integrity. The device substrate material can also be opaque to visible light such as, for example, stainless steel, crystalline silicon, poly-silicon, or the like.

OEL devices comprising the compositions of the invention can be used in a variety of light-emitting articles and applications. Such articles include, for example, displays (for use in, for example, personal computers, cell phones, watches, handheld devices, toys, automotive or aerospace applications, and the like), microdisplays including head-mounted microdisplays, lamps (for use as, for example, backlights of liquid crystal displays), indicator lights, and the like.

In some light-emitting articles, the device layer includes one or more OEL devices that emit light through the device substrate toward a viewer position (that is, an intended destination for the emitted light whether it be an actual human observer, a screen, an optical component, an electronic device, or the like). Optionally, additional optical elements or other layers or devices suitable for use with electronic displays, devices, or lamps (for example, transistor arrays, color filters, polarizers, wave plates, diffusers, light guides, lenses, light control films, brightness enhancement films, insulators, barrier ribs, black matrix, mask works, and the like) can be provided between the device layer and the viewer position. In other embodiments, the device layer can be positioned between the device substrate and the viewer position. A “bottom emitting” configuration can be used when the substrate is transmissive to light emitted by the organic emitting layer of the device and the substrate. The inverted, or “top emitting,” configuration can be used when the electrode disposed between the substrate and the organic emitting layer of the device does not transmit the light emitted by the device.

The device layer can include one or more OEL devices arranged in any suitable manner. For example, in lamp applications for backlighting liquid crystal display modules, the device layer might constitute a single OEL device that spans an entire intended backlight area. Alternatively, in other lamp applications, the device layer might contain a plurality of closely spaced devices that can be contemporaneously activated.

In some display applications, it can be desirable for the device layer to include a plurality of independently addressable OEL devices that emit the same or different colors. Each device might represent a separate pixel or a separate sub-pixel of a pixilated display (for example, a high resolution display), a separate segment or sub-segment of a segmented display (for example, a low information content display), or a separate icon or portion of an icon, or lamp for an icon (for example, in indicator applications).

Methods for Fabricating Organic Electroluminescent Device Layers

To form the organic emitting layer of the devices of the invention, the compositions of the invention can be solution deposited (for example, by spin coating, dip coating, ink jet printing, casting, or other known techniques) in a thin layer onto the anode. Such thin layer methods are described, for example, in U.S. Pat. No. 5,408,109 (Heeger et al.).

In certain applications, it is desirable to pattern one or more layers of an OEL device onto a substrate, for example, to fabricate high resolution emissive displays. Methods for patterning include selective transfer such as, for example, thermal transfer, photolithographic patterning, inkjet printing, screen printing, and the like.

Thermal transfer is a process by which light is converted to heat through a donor film or sheet. The heat causes the organic electronic material coated on the backside of the donor sheet to be activated, wetting out and adhering onto the receptor substrate. Subsequent peel-back of the donor sheet, generally under ambient conditions, results in a pattern of the organic electronic material left on the receptor substrate.

The organic electroluminescent compositions of the invention, either as MFs or MDPs, can be successfully patterned onto substrates using methods of thermal transfer, including laser thermal transfer. The present invention provides a method for making OEL devices comprising selectively transferring an organic electroluminescent composition of the invention from a donor sheet to a receptor substrate. The present invention also provides a thermal transfer donor sheet comprising a transfer layer comprising an organic electroluminescent composition of the invention.

Preferably, the method of thermal transfer used for making OEL devices is laser thermal transfer. Laser thermal transfer is described in U.S. Pat. No. 6,242,152 (Staral et al.), U.S. Pat. No. 6,228,555 (Hoffend et al.), U.S. Pat. No. 6,228,543 (Mizuno et al.), U.S. Pat. No. 6,221,553 (Wolk et al.), U.S. Pat. No. 6,221,543 (Guehler et al.), U.S. Pat. No. 6,214,520 (Wolk et al.), U.S. Pat. No. 6,194,119 (Wolk et al.), U.S. Pat. No. 6,114,088 (Wolk et al.), U.S. Pat. No. 5,998,085 (Isberg et al.), U.S. Pat. No. 5,725,989 (Chang et al.), U.S. Pat. No. 5,710,097 (Staral et al.), U.S. Pat. No. 5,695,907 (Chang), and U.S. Pat. No. 5,693,446 (Staral et al.).

The donor sheets of the invention comprise a base substrate, a light-to-heat conversion (LTHC) layer, and a transfer layer comprising an organic electroluminescent composition of the invention. Donor sheets can also optionally comprise one or more other layers such as, for example, underlayers, interlayers, or priming layers.

The donor sheet substrate can be, for example, a polymer film. One suitable type of polymer film is a polyester film such as, for example, polyethylene terephthalate (PET) or polyethylene naphthalate (PEN) films. However, other films with sufficient optical properties, including high transmission of light at a particular wavelength, or sufficient mechanical and thermal stability properties, depending on the particular application, can be used. The donor substrate, in at least some instances, is flat so that uniform coatings can be formed thereon. The donor substrate is also typically selected from materials that remain stable despite heating of one or more layers of the donor. However, as described below, the inclusion of an underlayer between the substrate and an LTHC layer can be used to insulate the substrate from heat generated in the LTHC layer during imaging. The typical thickness of the donor substrate ranges from about 0.025 to about 0.15 mm, preferably from about 0.05 to about 0.1 mm, although thicker or thinner donor substrates can be used.

The materials used to form the donor substrate and an optional adjacent underlayer can be selected to improve adhesion between the donor substrate and the underlayer, to control heat transport between the substrate and the underlayer, to control imaging radiation transport to the LTHC layer, to reduce imaging defects and the like. An optional priming layer can be used to increase uniformity during the coating of subsequent layers onto the substrate and also increase the bonding strength between the donor substrate and adjacent layers.

An optional underlayer can be coated or otherwise disposed between a donor substrate and the LTHC layer, for example to control heat flow between the substrate and the LTHC layer during imaging or to provide mechanical stability to the donor element for storage, handling, donor processing, or imaging. Examples of suitable underlayers and methods of providing underlayers are disclosed, for example in U.S. Pat. No. 6,284,425 (Staral et al.).

The underlayer can include materials that impart desired mechanical or thermal properties to the donor element. For example, the underlayer can include materials that exhibit a low specific heat×density or low thermal conductivity relative to the donor substrate. Such an underlayer can be used to increase heat flow to the transfer layer, for example to improve the imaging sensitivity of the donor.

The underlayer can also include materials for their mechanical properties or for adhesion between the substrate and the LTHC. Using an underlayer that improves adhesion between the substrate and the LTHC layer can result in less distortion in the transferred image. In other cases, however it can be desirable to employ underlayers that promote at least some degree of separation between or among layers during imaging, for example to produce an air gap between layers during imaging that can provide a thermal insulating function. Separation during imaging can also provide a channel for the release of gases that can be generated by heating of the LTHC layer during imaging. Providing such a channel can lead to fewer imaging defects.

The underlayer can be substantially transparent at the imaging wavelength, or can also be at least partially absorptive or reflective of imaging radiation. Attenuation or reflection of imaging radiation by the underlayer can be used to control heat generation during imaging.

The LTHC layer of the donor sheets of the present invention couple irradiation energy into the donor sheet. The LTHC layer preferably includes a radiation absorber that absorbs incident radiation (for example, laser light) and converts at least a portion of the incident radiation into heat to enable transfer of the transfer layer from the donor sheet to the receptor substrate.

Generally, the radiation absorber(s) in the LTHC layer absorb light in the infrared, visible, or ultraviolet regions of the electromagnetic spectrum and convert the absorbed radiation into heat. The radiation absorber(s) are typically highly absorptive of the selected imaging radiation, providing an LTHC layer with an optical density at the wavelength of the imaging radiation in the range of about 0.2 to 3 or higher. Optical density of a layer is the absolute value of the logarithm (base 10) of the ratio of the intensity of light transmitted through the layer to the intensity of light incident on the layer.

Radiation absorber material can be uniformly disposed throughout the LTHC layer or can be non-homogeneously distributed. For example, as described in U.S. patent application Ser. No. 09/474,002, non-homogeneous LTHC layers can be used to control temperature profiles in donor elements. This can give rise to donor sheets that have improved transfer properties (for example, better fidelity between the intended transfer patterns and actual transfer patterns).

Suitable radiation absorbing materials can include, for example, dyes (for example, visible dyes, ultraviolet (UV) dyes, infrared (IR) dyes, fluorescent dyes, and radiation-polarizing dyes), pigments, metals, metal compounds, metal films, and other suitable absorbing materials. Examples of suitable radiation absorbers includes carbon black, metal oxides, and metal sulfides. One example of a suitable LTHC layer can include a pigment, such as carbon black, and a binder, such as an organic polymer. Another suitable LTHC layer includes metal or metal/metal oxide formed as a thin film, for example, black aluminum (that is, a partially oxidized aluminum having a black visual appearance). Metallic and metal compound films can be formed by techniques, such as, for example, sputtering and evaporative deposition. Particulate coatings can be formed using a binder and any suitable dry or wet coating techniques. LTHC layers can also be formed by combining two or more LTHC layers containing similar or dissimilar materials. For example, an LTHC layer can be formed by vapor depositing a thin layer of black aluminum over a coating that contains carbon black disposed in a binder.

Dyes suitable for use as radiation absorbers in a LTHC layer can be present in particulate form, dissolved in a binder material, or at least partially dispersed in a binder material. When dispersed particulate radiation absorbers are used, the particle size can be, at least in some instances, about 10 μm or less, and can be about 1 μm or less. Suitable dyes include those dyes that absorb in the IR region of the spectrum. A specific dye can be chosen based on factors such as, solubility in, and compatibility with, a specific binder or coating solvent, as well as the wavelength range of absorption.

Pigmentary materials can also be used in the LTHC layer as radiation absorbers. Examples of suitable pigments include carbon black and graphite, as well as phthalocyanines, nickel dithiolenes, and other pigments described in U.S. Pat. No. 5,166,024 (Bugner et al.) and U.S. Pat. No. 5,351,617 (Williams et al.). Additionally, black azo pigments based on copper or chromium complexes of, for example, pyrazolone yellow, dianisidine red, and nickel azo yellow can be useful. Inorganic pigments can also be used, including, for example, oxides and sulfides of metals such as aluminum, bismuth, tin, indium, zinc, titanium, chromium, molybdenum, tungsten, cobalt, iridium, nickel, palladium, platinum, copper, silver, gold, zirconium, iron, lead, and tellurium. Metal borides, carbides, nitrides, carbonitrides, bronze-structured oxides, and oxides structurally related to the bronze family (for example, WO_{2.9}) can also be used.

Metal radiation absorbers can be used, either in the form of particles, as described for instance in U.S. Pat. No. 4,252,671 (Smith), or as films, as disclosed in U.S. Pat. No. 5,256,506 (Ellis et al.). Suitable metals include, for example, aluminum, bismuth, tin, indium, tellurium and zinc.

Suitable binders for use in the LTHC layer include film-forming polymers, such as, for example, phenolic resins (for example, novolak and resole resins), polyvinyl butyral resins, polyvinyl acetates, polyvinyl acetals, polyvinylidene chlorides, polyacrylates, cellulosic ethers and esters, nitrocelluloses, and polycarbonates. Suitable binders include monomers, oligomers, or polymers that have been, or can be, polymerized or crosslinked. Additives such as photoinitiators can also be included to facilitate crosslinking of the LTHC binder. In some embodiments, the binder is primarily formed using a coating of crosslinkable monomers or oligomers with optional polymer.

The inclusion of a thermoplastic resin (for example, polymer) can improve, in at least some instances, the performance (for exmaple, transfer properties or coatability) of the LTHC layer. The binder can include about 25 to about 50 weight percent (excluding the solvent when calculating weight percent) thermoplastic resin (preferably, about 30 to about 45 weight percent thermoplastic resin), although lower amounts of thermoplastic resin can be used (for example, about 1 to about 15 weight percent). The thermoplastic resin is typically chosen to be compatible (that is, form a one-phase combination) with the other materials of the binder. Typically, a thermoplastic resin that has a solubility parameter in the range of 9 to 13 (cal/cm³)^{1/2}, preferably, 9.5 to 12 (cal/cm³)^{1/2}, is chosen for the binder. Examples of suitable thermoplastic resins include, for example, polyacrylics, styrene-acrylic polymers and resins, and polyvinyl butyral.

Conventional coating aids such as, for example, surfactants and dispersing agents can be added to facilitate the coating process. The LTHC layer can be coated onto the donor substrate using a variety of coating methods known in the art. A polymeric or organic LTHC layer can generally be coated to a thickness of about 0.05 μm to about 20 μm, preferably, about 0.5 μm to about 10 μm, and, more preferably, about 1 μm to about 7 μm. An inorganic LTHC layer can generally be coated to a thickness in the range of about 0.0005 to about 10 μm, and preferably, about 0.001 to about 1 μm.

An optional interlayer can be disposed between the LTHC layer and transfer layer. The interlayer can provide a number of benefits. The interlayer can be a barrier against the transfer of material from the light-to-heat conversion layer. It can also modulate the temperature attained in the transfer layer so that thermally unstable materials can be transferred. For example, the interlayer can act as a thermal diffuser to control the temperature at the interface between the interlayer and the transfer layer relative to the temperature attained in the LTHC layer. This can improve the quality (that is, surface roughness, edge roughness, etc.) of the transferred layer. The presence of an interlayer can also result in improved plastic memory in the transferred material.

Typically, the interlayer has high thermal resistance. Preferably, the interlayer does not distort or chemically decompose under the imaging conditions, particularly to an extent that renders the transferred image non-functional. The interlayer typically remains in contact with the LTHC layer during the transfer process and is not substantially transferred with the transfer layer.

Suitable interlayers include, for example, polymer films, metal layers (for example, vapor deposited metal layers), inorganic layers (for example, sol-gel deposited layers and vapor deposited layers of inorganic oxides (for example, silica, titania, and other metal oxides)), and organic/inorganic composite layers. Organic materials suitable as interlayer materials include both thermoset and thermoplastic materials.

Suitable thermoset materials include resins that can be crosslinked by heat, radiation, or chemical treatment such as, for example, crosslinked or crosslinkable polyacrylates, polymethacrylates, polyesters, epoxies, and polyurethanes. The thermoset materials can be coated onto the LTHC layer as, for example, thermoplastic precursors and subsequently crosslinked to form a crosslinked interlayer.

Suitable thermoplastic materials include, for example, polyacrylates, polymethacrylates, polystyrenes, polyurethanes, polysulfones, polyesters, and polyimides. These thermoplastic organic materials can be applied via conventional coating techniques (for example, solvent coating, spray coating, or extrusion coating). Typically, the glass transition temperature (T_{g}) of thermoplastic materials suitable for use in the interlayer is about 25° C. or greater, preferably about 50° C. or greater. The interlayer can be either transmissive, absorbing, reflective, or some combination thereof, at the imaging radiation wavelength.

Inorganic materials suitable as interlayer materials include, for example, metals, metal oxides, metal sulfides, and inorganic carbon coatings, including those materials that are highly transmissive or reflective at the imaging light wavelength. These materials can be applied to the LTHC layer via conventional techniques (for example, vacuum sputtering, vacuum evaporation, or plasma jet deposition).

The interlayer can contain additives, including, for example, photoinitiators, surfactants, pigments, plasticizers, and coating aids. The thickness of the interlayer can depend on factors such as, for example, the material of the interlayer, the material and properties of the LTHC layer, the material and properties of the transfer layer, the wavelength of the imaging radiation, and the duration of exposure of the donor sheet to imaging radiation. For polymer interlayers, the thickness of the interlayer typically is in the range of about 0.05 μm to about 10 μm. For inorganic interlayers (for example, metal or metal compound interlayers), the thickness of the interlayer typically is in the range of about 0.005 μm to about 10 μm.

The donor sheets of the invention also comprise a thermal transfer layer. The transfer layer includes an organic electroluminescent composition of the present invention and can include any other suitable material or materials, disposed in one or more light-emitting layers. The transfer layer is capable of being selectively transferred as a unit or in portions by any suitable transfer mechanism when the donor element is exposed to direct heating or to imaging radiation that can be absorbed by light-to-heat converter material and converted into heat. One way of providing the transfer layer is by solution coating the light-emitting layer material (that is, MFs and MDPs comprising the organic electroluminescent composition of the invention) onto the donor substrate or any of the layers described supra (for example, the underlayer, interlayer, or LTHC layer). Using this method, the light-emitting layer material can be solubilized by addition of a suitable compatible solvent, and coated onto the donor substrate or any one of the above layers by spin-coating, gravure coating, Mayer rod coating, knife coating and the like. The solvent chosen preferably does not undesirably interact with (for example, swell or dissolve) any of the already existing layers in the donor sheet. The coating can then be annealed and the solvent evaporated to leave a transfer layer.

The transfer layer can then be selectively thermally transferred from the resulting donor sheet or element to a proximately located receptor substrate. There can be, if desired, more than one transfer layer so that a multilayer construction is transferred using a single donor sheet. The receptor substrate can be any item suitable for a particular application including, for example, glass, transparent films, reflective films, metals, semiconductors, and plastics. For example, receptor substrates can be any type of substrate or display element suitable for display applications. Receptor substrates suitable for use in displays such as liquid crystal displays or emissive displays include rigid or flexible substrates that are substantially transmissive to visible light.

Examples of suitable rigid receptors include glass and rigid plastic that are coated or patterned with indium-tin-oxide (ITO) or that are circuitized with low temperature poly-silicon (LTPS) or other transistor structures, including organic transistors.

Suitable flexible substrates include substantially clear and transmissive polymer films, reflective films, transflective films, polarizing films, multilayer optical films, and the like. Flexible substrates can also be coated or patterned with electrode materials or transistors (for example transistor arrays formed directly on the flexible substrate or transferred to the flexible substrate after being formed on a temporary carrier substrate). Suitable polymer substrates include polyester base (for example, polyethylene terephthalate, polyethylene naphthalate), polycarbonate resins, polyolefin resins, polyvinyl resins (for example, polyvinyl chloride, polyvinylidene chloride, polyvinyl acetals, and the like), cellulose ester bases (for example, cellulose triacetate, cellulose acetate), and other conventional polymeric films used as supports. For making OELs on plastic substrates, it is often desirable to include a barrier film or coating on one or both surfaces of the plastic substrate to protect the organic light-emitting devices and their electrodes from exposure to undesired levels of water, oxygen, and the like.

Receptor substrates can be pre-patterned with any one or more of electrodes, transistors, capacitors, insulator ribs, spacers, color filters, black matrix, hole transport layers, electron transport layers, and other elements useful for electronic displays or other devices.

MFs and MDPs comprising the organic electroluminescent compositions of the invention can be selectively transferred from the donor sheet to the receptor substrate by placing the transfer layer of the donor sheet adjacent to the receptor substrate and selectively heating the donor sheet. For example, the donor sheet can be selectively heated by irradiating the donor sheet with imaging radiation that can be absorbed by the LTHC layer and converted into heat.

The donor sheet can be exposed to imaging radiation through its substrate, through the receptor substrate, or both. The radiation can include one or more wavelengths, including visible light, IR, or UV radiation from, for example, a laser, lamp, or other such radiation source. Preferably, the radiation source is a laser. Other selective heating methods can also be used, such as using a thermal print head or using a thermal hot stamp (for example, a patterned thermal hot stamp such as a heated silicone stamp that has a relief pattern that can be used to selectively heat a donor). Material from the thermal transfer layer can be selectively transferred to a receptor substrate in this manner to imagewise form patterns of the transferred material on the receptor.

In many instances, thermal transfer using light from, for example, a lamp or laser, to patternwise expose the donor can be advantageous because of the accuracy and precision that can often be achieved. The size and shape of the transferred pattern (for example, a line, circle, square, or other shape) can be controlled by, for example, selecting the size of the light beam, the exposure pattern of the light beam, the duration of directed beam contact with the donor sheet, or the materials of the donor sheet. The transferred pattern can also be controlled by irradiating the donor element through a mask.

### EXAMPLES

Objects and advantages of this invention are further illustrated by the following examples, but the particular materials and amounts thereof recited in these examples, as well as other conditions and details, should not be construed to unduly limit this invention.

### Synthesis of poly(N-vinylcarbazole-co-p-diphenylaminostyrene) (PVK-DPAS)

A copolymer of N-vinylcarbazole with a triarylamine-containing monomer was prepared as described below. The starting materials used in this example are available from Aldrich Chemicals of Milwaukee, Wis., with the exception of p-diphenylaminostyrene and others noted. P-diphenylaminostyrene was synthesized by a preparation similar to that described by Tew et al., Angew. Chem. Int. Ed., 39, 517 (2000) as follows. To a mixture of 4-(diphenylamino)benzaldehyde (20.06 g, 73 mmol, Fluka Chemicals, Milwaukee, Wis.), methyltriphenyl phosphonium bromide (26.22 g, 73 mmol) and dry tetrahydrofuran (450 mL) under nitrogen was added a 1M solution of potassium t-butoxide in tetrahydrofuran (80 mL, 80 mmol) over 5 minutes. The mixture was stirred for 17 hours at room temperature. Water (400 mL) was added and the tetrahydrofuran was removed under reduced pressure. The mixture was extracted with ether, and the combined organic layers were dried over MgSO₄ and concentrated under vacuum. The crude solid was purified by column chromatography on silica gel using a 50/50 mixture of methylene chloride and hexane to give a yellow solid that was further recrystallized once from hexane and its structure confirmed by magnetic resonance spectroscopy (NMR).

A copolymer containing this monomer was prepared as follows. A solution of 3.05 g N-vinylcarbazole and 0.42 g p-diphenylaminostyrene was prepared in 12.99 g methylethylketone. To this solution was added 0.0243 g of 2,2′-azobis(2-methylbutyronitrile) (VAZO™ 67, available from Dupont Chemicals, Wilmington, Del.). The resulting mixture was sparged with nitrogen gas for 20 minutes, sealed in a bottle, and stirred for 20 h at 80° C. After cooling to room temperature, the solution was poured into excess methanol (100 mL). The resulting precipitated polymer was collected by filtration and dried overnight in a vacuum oven at room temperature. This polymer contained 6.4 mol % of p-diphenylaminostyrene based on ¹H and ¹³C NMR, and had a weight average molecular weight of 14.3 kg/mol with a polydispersity of 2.8 based on gel permeation chromatography (GPC) measurements in tetrahydrofuran against polystyrene standards.

### Synthesis of Electron Transport Polymer, ODP1

Part A

Synthesis of 2,5-Dibromobenzoyl Chloride

Into a 2 L flask fitted with a reflux condenser and magnetic stir-bar was introduced 50 g (0.1786 mol) 2,5-dibromobenzoic acid and 150 ml of thionyl chloride. The mixture was refluxed for 8 hours. Most of the thionyl chloride was distilled off followed by removal of the remainder by rotary evaporation. Distillation gave 40 g 2,5-dibromobenzoyl chloride.

Part B

Synthesis of 4-Octoxybenzoylhydrazine

To the contents of the flask from Part A was added 387.14 g of 98% hydrazine. This was refluxed for 5 hours (106° C.). The cooled solution was poured into 3 L of water and the precipitated solid filtered, washed with copious amounts of water and dried in vacuo to give 4-octylbenzoylhydrazine (343 g, 91% yield, mp 90° C.).

Part C

Synthesis of 2,5-Dibromo-N′-[4-(octyloxy)benzoyl]benzohydrazide

50.88 g (0.1925 mole) 4-octoxybenzoyl hydrazine and 19.48 g (0.1925 mole) freshly distilled triethylamine were added to 800 mL of dichloromethane. To this was added with mechanical stirring 57.43 g of 2,4-dibromobenzoyl chloride. The product was filtered and recrystallized from dimethyl formamide (DMF)/water to give 79.38 g (78% yield) 2,5-Dibromo-N′-[4-(octyloxy)benzoyl]benzohydrazide.

Part D

Synthesis of 2-(2,5-Dibromophenyl)-5-[4-(octyloxy)phenyl]1,3,4-oxadiazole

Into a 2 L flask was introduced 39.1 g (0.0743 mol) of N-(2,5-dibromobenzoyl)-4-(octyloxy)benzohydrazide and 203 ml phosphorus oxychloride. The mixture was refluxed for 8 hrs and the solvent then evaporated under slight vacuum. The residue was poured onto crushed ice and allowed to stand until the next day. Filtration gave a sticky mass, which was dissolved in methanol, and solid material was obtained by addition of a little water. Filtration and drying gave 112 g of the required product as a white crystalline solid (59% yield).

Part E

Preparation of Electron Transport Polymer, ODP1

5.38 g (8.37 mmole) 2,7-Bis(4,4,5,5-tetramethyl-1,3,2-dioxaborolan-2-yl)-9,9-dioctyl-fluorene, 1.80 g (4.92 mmole) 2,7-dibromo-9,9-dioctylfluorene made as described in Ranger et al., Can. J. Chem., 1571 (1998) and 2.50 g (4.92 mmole) 2-(2,5-dibromophenyl)-5-[4-(octyloxy)phenyl]-1,3,4-oxadiazole made as described in Ranger et al., Chem. Commun., 1597 (1997) were mixed together with 0.85 g (2.09 mmole) ALIQUAT™ 336 (tricaprylylmethylammonium chloride, available from Aldrich Chemical) in 150 mL toluene. To this was added 28 mL of an aqueous 2M Na₂CO₃ solution, and the resulting mixture was then degassed with nitrogen for 2 hours at room temperature and then at 50° C. for a further 2 hours. 0.04 g (0.035 mmole) tetrakis(triphenylphosphine)palladium (0) available from Strem Chemical, Newburyport, Mass. was then added to the mixture. The resulting mixture was heated at reflux under nitrogen for 16 hours. A nitrogen purged solution of 1 mL bromobenzene in toluene was added followed by a further charge of 0.04 g of tetrakis(triphenylphosphine)palladium (0), and the resulting mixture was then refluxed for another 16 hrs. After the reaction mixture was cooled to room temperature, it was poured into 2 L methanol and the precipitate collected by filtration. The precipitate was purified by repeated dissolution in methylene chloride and then precipitation in methanol. The product was obtained as 5.4 g of a light powder. Gel permeation chromatography analysis of the product gave: Mw 7.30×10⁴, Mn 2.36×10⁴, and polydispersity of 2.95.

### Synthesis of Electron-Transport Polymer, ODP2

Part A

Synthesis of Methyl 4-octoxybenzoate

Into a flask were introduced 251.0 g (1.65 mol) of methyl 4-hydroybenzoate, 276.37 g (1.99 mol) potassium carbonate and 1200 g of acetone. This was refluxed for 45 min followed by the dropwise addition of 386.17 g (1.99 mol) of 1-octylbromide over a 1 hour period. The reaction mixture was refluxed for two days. Filtration of the cooled reaction mixture and evaporation of the filtrate gave an oil. This was taken up in ethyl acetate and extracted with 5% NaOH (2×100 ml) followed by water (2×100 ml). The organic layer was dried (MgSO₄), concentrated, and transferred to a 1 L three necked flask. The contents of the flask were subjected to high vacuum distillation to remove the excess 1-octylbromide. The pot residue was essentially pure methyl 4-octoxybenzoate (376 g, 86%).

Part B

Synthesis of 2,4-dichlorobenzoyl Chloride

Into a 2 L flask fitted with a reflux condenser and magnetic stir-bar was introduced 150 g (0.785 mol) 2,5-dichlorobenzoic acid and 575 ml (7.85 mol) of thionyl chloride. The mixture was refluxed for 8 hours. Most of the thionyl chloride was distilled off followed by removal of the remainder by rotary evaporation. Distillation gave 130 g (79% yield) of 2,4-dichlorobenzoyl chloride (pot temperature 110° C.; distillation temp 70° C./0.70 mm Hg).

Part C

Synthesis of 2,5-dichlor-N′-[4-(octyloxy)benzoyl]benzohydrazide.

Under a blanket of nitrogen, 8.8 g (0.087 mol) 2,4-dichlorobenzoyl chloride was added to a solution of 23.0 g (0.087 mol) 4-octoxybenzoyl hydrazine and 12.13 ml (8.8 g, 0.087 mol) freshly distilled triethylamine in 348 ml dry chloroform. After about one hour of stirring a dense white precipitate of the product was formed. Stirring was continued until the next day. The product was collected by filtration and recrystallized from ethanol/water to give 31 g (81.5% yield) of 2,5-dichlor-N′-[4-(octyloxy)benzoyl]benzohydrazide as a white solid.

Part D

Synthesis of 2-(2,5-dichlorophenyl)-5-[4-(octyloxy)phenyl]-1,3,4-oxadiazole

Into a 250 ml flask fitted with a mechanical stirrer and thermometer was introduced 30 g (0.0686 mol) 2,5-dichlor-N′-[4-(octyloxy)benzoyl]benzohydrazide and 181 ml phosphorus oxychloride. This refluxed and stirred for 8 hrs. About 100 ml of phosphorus oxychloride was distilled off under reduced pressure. The cooled residue was poured onto water and crushed ice with manual stirring and allowed to stand until the ice had melted. The precipitated white solid was collected by filtration, dried and recrystallized from ethanol. There was obtained 25.7 g (89% yield, mp 86° C.) of 2-(2,5-dichlorophenyl)-5-[4-(octyloxy)phenyl]-1,3,4-oxadiazole. The structure was confirmed by NMR.

Part E

Polymerization of 2-(2,5-Dichlorophenyl)-5-[4-(octyloxy)phenyl]-1,3,4-oxadiazole.

Into a flask fitted with a septum and nitrogen purge was introduced 4.10 g (9.77 mmol) of 2-(2,5-dichlorophenyl)-5-[4-(octyloxy)phenyl]-1,3,4-oxadiazol 2.85 g (10.89 mmol) of triphenylphosphine, and 0.31 g (1.421 mmol) of anhydrous nickel (II) bromide. To this was added 75 ml dry DMF and 25 ml dry toluene. This was azeotroped with the use of a Dean-Stark condenser followed by distilling off much of the toluene. To the cooled reaction solution was added a further 0.31 g (1.421 mmol) of anhydrous nickel (II) bromide under a strong nitrogen purge. This was heated at 80° C. for 30 minutes followed by the addition of 1.0 g chlorobenzene as end-capping agent. The reaction was allowed to proceed for 8 hours at 80° C. The cooled reaction mixture was poured into about 500 ml acetone and filtered. The solid cake was taken up in methylene chloride and 1N HCl added and the two-phase system stirred for about an hour. The resulting solids were filtered off and the filtrate transferred to a separatory funnel. The lower organic layer was separated and poured into an excess of methanol. The solid was collected, washed with methanol and dried to give 2.8 g of polymer.

GPC analysis gave a weight average molecular weight (Mw) of 2.49×10⁴, a number average molecular weight (Mn) of 8.40×10³, and a polydispersity (PD) of 2.97.

### Synthesis of 1,3,5-tris(5-(p-octyloxyphenyl)-1,3,4-oxadiazol-2-yl)benzene (OPOB)

Part A

Synthesis of 5-(p-octyloxyphenyl)-1,2,3,4-tetrazole.

20.8 grams of p-(octyloxy)benzonitrile (Aldrich Chemical Company, Milwaukee, Wis.), 8.8 grams of sodium azide (Aldrich Chemical Company, Milwaukee, Wis.), and 7.2 grams of ammonium chloride were mixed together under nitrogen atmosphere in 90 ml of dry DMF (dried by stirring with potassium hydroxide and distilling from calcium oxide under nitrogen atmosphere). After the reaction mixture was stirred overnight under nitrogen at 100° C., the mixture was cooled to room temperature, and mixed with 700 ml deionized water, after which the reaction mixture was acidified with dilute hydrochloric acid, and the resulting white solid was collected by filtration. The solid was washed with 300 ml of deionized water followed by 300 ml of hexane, followed by drying in a desiccator under vacuum. 23.9 g of white solid product was collected and its structure confirmed by NMR.

Part B

Synthesis of 1,3,5-tris(5-(p-octyloxyphenyl)-1,3,4-oxadiazol-2-yl)benzene (OPOB)

5 grams of 5-(p-octyooxyphenyl)-1,2,3,4-tetrazole and 1.5 grams of 1,3,5-tricarbonyltrichlobenzene (Aldrich Chemical Company, Milwaukee, Wis.) were stirred overnight in 20 ml of dry pyridine at reflux under nitrogen atmosphere. After cooling down to room temperature and addition of methanol, a white precipitate formed, which was filtered and washed with additional methanol, followed by drying in the desiccator under vacuum. 3.5 grams of the crude product were isolated, which was further purified by column chromatography on silica gel with 50:50 mixture of dichloromethane:ethylacetate and its structure confirmed by NMR.

### Synthesis of 4,4′,4″-tris((4-diphenylamino)phenyl)triphenylamine (TDAPTA)

Part A

Synthesis of 4-Bromo-N,N-diphenylaniline.

4-Bromo-N,N-diphenylaniline was made essentially as described in Creason et al., J. Org. Chem., 37, 4440 (1972).

Part B

Synthesis of N,N-diphenyl-4-(4,4,5,5-tetramethyl-1,3,2-dioxaborolan-2-yl)aniline

82.57 mL of a 2.5M solution of n-Butyllithium (Aldrich Chemical) was added dropwise via syringe to a solution of 24 g (0.074 mole) 4-bromo-N,N-diphenylaniline in 175 ml dry tetrahydrofuran (THF) and −78° C. Stirring was continued at −78° C. for an hour and then at −50° C. for an hour. The mixture was cooled to −78° C. and 17.22 g (0.0925 mole) 2-isopropoxy-4,4,5,5-tetramethyl-1,3,2-dioxaborolane (Aldrich Chemical Co.) was added via syringe in one portion. The temperature was maintained at −78° C. for three hours. The cooling bath was removed and the reaction left to warm to room temperature while standing for 12 hours. The reaction mixture was poured into saturated ammonium acetate and extracted with ether. The ether layer was dried over magnesium sulfate and concentrated to give a viscous oil. Purification by column chromatography (silica gel eluting with hexane:toluene mixtures of increasing gradient from 100% hexane to 40% hexane) gave N,N-diphenyl-4-(4,4,5,5-tetramethyl-1,3,2-dioxaborolan-2-yl)aniline as an oil (19.9 g, 72.8% yield), which slowly crystallized to a solid on standing.

Part C

Synthesis of TDAPTA

10.90 g (29.4 mmol, 3.15 equiv) N,N-diphenyl-4-(4,4,5,5-tetramethyl-1,3,2-dioxaborolan-2-yl)aniline, 4.49 g (9.30 mmol, 1 equiv) tris(4-bromophenyl)amine (Aldrich Chemical Co.), 1.41 g(3.5 mmol, 0.375 equiv) Aliquat™ 336 (Aldrich Chemical Co.) and 17 mL 2M aqueous Na₂CO₃ solution (70.4 mmol, 7.55 equiv) were added to 160 mL of toluene. This mixture was purged with a stream of nitrogen for 1 hr followed by 1 hr at 50° C. Under a nitrogen purge, 130 mg tetrakis(triphenylphosphine) palladium(0)(0.10 mmol, 0.012 equiv) was added. The reaction mixture was then refluxed for 18 hrs. The cooled reaction was transferred to a separatory funnel and the organic layer collected. The aqueous layer was extracted with ether and the combined organic layers dried and evaporated to give an oily solid mass. The oil was taken up in hot toluene and cooled to precipitate a light brown solid. The precipitate was filtered (7.3 g) and shown by thin layer chromatography (hexane/toluene 1:1) to consist of a major component. Column chromatography (silica gel with toluene:hexane gradient from 100% toluene) gave 5.10 g (56% yield) of TDAPTA. Positive-ion mass spectrum gave m/z 974 (C₇₂H₅₄N₄ requires M⁺ 974).

### Synthesis of Polyfluorene Copolymer Containing 50 mole Percent of Electron Transport Oxadiazoles (ODP3)

12.84 g (20 mmole) 9,9-dioctyl-2,7-bis(4,4,5,5-tetramethyl-1,3,2-dioxaborolan-2-yl)-fluorene and 8.856 g (18 mmole) 2-(2,5-dibromophenyl)-5-[4-octyloxy)phenyl]-1,3,4-oxadiazole were mixed together with 2.02 g (5 mmole) Aliquat™ 336 in 212 mL toluene. To this suspension was added 36 mL of 2M aqueous Na₂CO₃ solution and the mixture was then purged with nitrogen for one hour and then at 65° C.; for half an hour. 0.232 g (0.2 mmole) tetrakis(triphenylphosphine)palladium(0) was then added under nitrogen. The reaction was refluxed under nitrogen for 3 days. 1 mL of bromobenzene was added and the reaction further refluxed for 18 hours. After the reaction was cooled down, it was poured to 500 mL of methanol and water (9:1). The polymer precipitated out as rubbery glue-like semi solid. The solid was filtered and dried under suction. The cake was redissolved in chloroform and precipitated from methanol. The precipitate was filtered and washed with methanol to give a white solid. GPC showed a Mw=21K, Mn=7.6K, PD=2.8.

### Synthesis of Bis(2-(5′-trifluoromethylphenyl)pyridinato-N,C^{2′})iridium(III) acetylacetonate (5TFM PPIr)

4.18 g (22 mmole) 3-Trifluoromethylphenyl boronic acid (Aldrich Chemical Co.), 0.78 g (17.6 mmole) 2-bromopyridine and 5.04 g (60 mmole) NaHCO₃ were mixed together in 60 mL ethylene glycol dimethyl ether. The solution was purged with nitrogen for an hour before 0.5 g (Ph₃P)₄Pd was added. The mixture was refluxed under nitrogen overnight. After the reaction was cooled down, the mixture was extracted with ether, and the combined ether layer was washed with water and brine. After ether was removed by rotary evaporation, the crude product was vacuum distilled to give 2.0 g of product as light brown oil. Product structure was confirmed by NMR.

1.85 g (8.29 mmol) 2-(3′-Trifluoromethylphenyl)pyridine and 1.24 g IrCl₃.xH₂O were mixed together in 84 ml 2-ethoxyethanol and 28 ml water. The mixture was refluxed under nitrogen overnight. After the reaction was cooled down, 100 ml of water was added and precipitate was formed. The precipitate was filtered and washed consecutively with water, diethyl ether and hexane to give 1.42 g of a light green solid. Product structure was confirmed by NMR.

1.42 g of the light green solid was suspended in 40 ml of 2-ethoxyethanol. 0.23 g of Na₂CO₃ and 2 g of 2,4-pentanedione were added. The suspension was refluxed under nitrogen overnight. The resulted solution was added 40 ml of water to precipitate out a greenish powder. The powder was filtered and washed consecutively with water, diethyl ether and hexane to give 1 g of a green powder. Half of the compound was subjected to sublimation under 2×10⁻⁶ torr at 180-230° C. 0.37 g of an orange powder was obtained. Product structure was confirmed by NMR.

### Comparative Examples A-D

### MDP Organic Electroluminescent Devices Comprising PVK:PBD Blends Doped with Phosphorescent Iridium Emitters

Comparative Examples A-D describe initial electroluminescence performance and operation lifetimes of conventional molecularly doped polymer (MDP) organic electroluminescent devices made with a MPD layer comprising hole-transport polymer, poly(9-vinylcarbazole) (PVK), electron-transport material, 2-(4-biphenyl)-5-(4-tert-butylphenyl)-1,3,4-oxadazole (PBD); and various emissive dopants.

Indium-tin-oxide(ITO)-glass substrates (Applied Films Corporation, Longmont, Col.; about 25 ohms/square) were rinsed in acetone, dried with nitrogen, and rubbed with TX1010 Vectra™ Sealed-Border Wipers (Texwipe, Upper Saddle River, N.J.) soaked in methanol. The substrates were then subjected to oxygen plasma treatment at 200 mTorr base oxygen pressure and output power of 50 W in a Technics Micro Reactive Ion Etcher, Series 80 (K&M Company, Dublin,Calif.). Poly(3,4-ethylenedioxythiophene)/poly(styrenesulfonic acid), available as PEDT 4083 (Bayer Corp, Pittsburgh, Pa., PEDT 4083) was filtered through 0.2 μm nylon microfilters and then spin-coated from its water suspension at 2500 RPM spin speed onto prepared substrates. The resulting coated substrates were annealed under nitrogen gas flow at 110° C. for about 15 minutes. Bis(2-phenylpyridinato-N,C^{2′}) iridium(III) acetylacetonate (PPIr) and bis(2-benzo[5]thienylpyridinato-N,C^{2′}) iridium(III) acetylacetonate (BTPIr) complexes were synthesized as reported in the literature (see, for example, Lamansky et al., Inorg. Chem., 40, 1704 (2001)).

25 mg of PVK (Polymer Source Inc., Dorval, Quebec, Canada), 10 mg of PBD (Dojindo Molecular Technologies, Gaithersburg, Md.) and 2 mg of PPIr or BTPIr were dissolved in 1.8 ml chloroform. The resulting solutions were filtered through 0.2 μm nylon microfilters and spin-coated onto ITO-glass/PEDT 4083 substrates at a spin speed of 2500 RPM to form the MDP layer.

In Comparative Examples B and D, a layer of electron-transport material, tris(8-hydroxyquinolate) aluminum (III) (Alq), available from H. W. Sands, Jupiter, Fla. was deposited onto the MDP layer under vacuum (ca. 10⁻⁵ torr) with sublimation rates 0.5-2 Å/s. Each device was capped with a cathode composed of about 7-10 Å of lithium fluoride (Alfa Aesar Co., Ward Hill, Mass.) and 2000 Å of aluminum (Alfa Aesar Co.), deposited under high vacuum (10⁻⁶-10⁻⁵ torr)at rates of 0.5 Å/s for LiF, and 15-20 Å/s for Al. Device electroluminescence and luminance-current-voltage characteristics were measured with current densities ranging between 2 and 20 mA/cm². Operation lifetime tests were conducted under continuous constant current for all tested devices.

Performance results are summarized in Table 1. In spite of high peak efficiency observed in devices A-D (for example peak efficiency of 25-35 Cd/A for device A and 3-4 Cd/A for device C), operation lifetimes, which are defined herein as the time required to reach half of the initial luminance at given constant current, do not extend beyond about 10 hours.

### Comparative Examples E and F

### MDP Organic Electroluminescent Devices Comprising Relatively High Ionization Potential Hole-Transport Material

A solution of 15 mg of PVK, 10 mg of 4,4′-bis(carbazol-9-yl) biphenyl (CBP), available from H. W. Sands, 10 mg of PBD, and 2 mg of PPIr in 1.8 ml chloroform and a second solution of 15 mg of PVK, 10 mg of N,N′-bis(naphthalene-1-yl)-N,N′-bis(phenyl)benzidine (TPD), also available from H. W. Sands, 10 mg of PBD and 2 mg of PPIr in 1.8 ml chloroform were spin-coated onto separate ITO/PEDT 4083 substrates prepared essentially as described in Comparative Example B. Devices of Examples E and F were fabricated according to the procedure described in Comparative Example B.

Device performance and lifetimes of devices E and F are summarized in Table 1. Addition of relatively high-ionization potential hole-transporting tertiary aromatic amines such as CBP and TPD to the PVK:PBD matrix does not cause any significant improvements in operation lifetimes of devices E and F. Half lives of less than 20 hours and approximately 30 hours are observed for CBP-containing device E and TPD-containing device F, respectively.

### Examples 1-4

### MDP Organic Electroluminescent Devices Comprising the Organic Electroluminescent Compositions of the Invention

Solutions prepared essentially as described in Comparative Example E incorporating 15 mg PVK, 4,4′,4″-tris(N-(3-methylphenyl)-N-phenylamino)triphenylamine (MTDATA), available from H. W. Sands, 10 mg PBD, and either 2 mg PPIr or 2 mg BTPIr in 1.8 ml chloroform were spin-coated onto ITO/PEDT 4083 substrates prepared essentially as described in Comparative Example A or Comparative Example B. Devices 1 and 2 were made according procedures described in Comparative Examples A or B respectively.

Device performance and lifetimes of devices 1-4 are summarized in Table 1. All devices 1-4 show lower operation voltages (for example 7-8 V at 4 mA/cm²) and significantly improved operation lifetimes (0.5-2×10³ hours at current density of 1.6-1.7 mA/cm²) compared to the devices of Comparative Examples A-F.

### Comparative Examples G and H and Examples 5 and 6

### MDP Organic Electroluminescent Devices Comprising Hole-Transporting Polymer PVK-DPAS

Solutions were prepared using essentially the procedure of Comparative Example A, except that 25 mg PVK-DPAS, 10 mg PBD, and either 2 mg PPIr or 2 mg BTPIr in 1.8 ml chloroform were spin-coated onto glass-ITO/PEDT 4083 substrates for preparation of the devices evaluated in Comparative Examples G and H respectively or 15 mg PVK-DPAS, 10 mg MTDATA, 10 mg PBD, and either 2 mg PPIr or 2 mg BTPIr in 1.8 ml chloroform were spin-coated onto glass-ITO/PEDT 4083 substrates for preparation of the devices in Examples 5 and 6. Devices of Comparative Examples G and H and Examples 5 and 6 were fabricated according to the procedure described in Comparative Example B.

Device performance and lifetimes of devices of Comparative Examples G and H and Examples 5 and 6 are summarized in Table 1. PVK-DPAS-based devices of Comparative Examples G and H showed operation lifetimes of only 1 hour, whereas the compositions of the invention demonstrated lifetimes from 60 (Example 5) to 200 hours (Example 6). This example, with Examples 1-6 show that using the organic electroluminescent compositions of the invention in MDP devices leads to lifetime and operation voltage improvements with a wide range of hole transport polymer matrices.

### Examples 7-8 and Comparative Example I

### MDP Organic Electroluminescent Devices Comprising Electrically Inert Polystyrene (PS)

Solutions were prepared as follows: 10 mg poly(styrene) (PS) (M_{w}=90,000), available from Aldrich Chemical, Milwaukee, Wis., 15 mg MTDATA, 10 mg PBD, and 2 mg BTPIr were dissolved in 1.8 ml chloroform which was then spin-coated onto glass ITO/PEDT 4083 substrates according the procedure described in Comparative Example A to form Example 7. Similarly, 15 mg PS, 10 mg MTDATA, 10 mg PBD, and 2 mg BTPIr was dissolved in 1.8 ml chloroform and spun-coated to form Example 8. 10 mg PS, 15 mg 4,4′,4′-tris(carbazol-9-yl) biphenyl (TCTA), available from H. W. Sands, 10 mg PBD, and 2 mg BTPIr (2 mg) were dissolved in 1.8 ml chloroform and spin-coated to form Comparative Example I. The devices of Examples 7 and 8 and Comparative Example I were fabricated using the procedure described in Comparative Example B.

Device performance and lifetimes are summarized in Table 1. PS-based MDP device I, which contained a relatively high ionization potential tertiary aromatic amine (TCTA) exhibited low operation lifetime (7 hours at constant current density drive of 1.6 mA/cm²). In comparison, PS-based MDP devices comprising the organic electroluminescent compositions of the invention exhibited operation lifetimes of 180-280 hours (Table 1). Example 7 demonstrates that MDP devices comprising electrically inert polymers and the organic electroluminescent compositions of the invention exhibit improved operation lifetimes whereas Example 8 demonstrates that MDP compositions with relatively high ionization potential tertiary aromatic amines exhibit lower operation lifetimes.

### Example 9-12

### MDP Organic Electroluminescent Devices Comprising Electron Transport Polymer, ODP1

Solutions were prepared essentially as in Comparative Example A incorporating ODP1, MTDATA and BTPIr in four different ratios in chloroform for Examples 9-12. The solutions were spin-coated onto ITO/PEDT 4083 substrates prepared essentially as described in Comparative Example B. Devices of examples 9-12 were fabricated essentially as in Comparative Example B.

Device performance and lifetimes of Examples 9-12 are summarized in Table 1. Operation lifetimes measured for devices 9-12 were in the 500-700 hour range at a current density of about 1.7 mA/cm². These Examples demonstrate that MDP devices comprising electron transport polymers and the organic electroluminescent compositions of the invention exhibit improved lifetimes.

### Comparative Example J and Example 13

### MDP Organic Electroluminescent Devices Comprising Electron Transport Polymer, ODP2

Solutions were prepared essentially as in Comparative Example A incorporating ODP2, CBP, and BTPIr into Comparative Example J and ODP2, CBP, MTDATA, and BTPIr into Example 13. The solutions were spin-coated onto ITO/PEDT 4083 substrates prepared essentially as described in Comparative Example B. Devices were fabricated for Examples J and 13 essentially as described in Comparative Example B.

Device performance and lifetimes of Comparative Example J and Example 13 are summarized in Table 1. Device 13 demonstrated an operation half life approaching 100 hours at a current density of 1.7 mA/cm² whereas under the same current Comparative Device J lost half of its initial luminance within 1 hour, indicating that the organic electroluminescent compositions of the invention ODP2 improves the operation lifetimes of the MDP devices comprising ODP2.

### Examples 14-15

### MDP Organic Electroluminescent Devices Comprising a PVK:MTDATA:PBD Host and PtOEP Dopant

15 mg PVK, 10 mg MTDATA, 10 mg PBD, and 2 mg 2,3,7,8,12,13,17,18-octaethyl-12H,23H-porphine platinum (II) (PtOEP) available from Mid-Century Chemicals, Chicago, Ill., were dissolved in 1.8 ml chloroform. The solution was spin-coated onto ITO/PEDT 4083 substrates prepared essentially as described in Comparative Example A and Comparative Example B. Devices 15 and 16 were fabricated essentially as described in Comparative Example A and Comparative Example B respectively.

Device performance and lifetimes of Examples 14 and 15 are summarized in Table 1. Operation half-lives of both MDP formulations fell into 600-700 hours range at a current density of 1.7 mA/cm² demonstrating that MDP devices comprising the organic electroluminescent compositions of the invention increase electroluminescence lifetime independent of which emissive dopant is used.

### Comparative Examples K and L and Examples 16 and 17

### MDP Electroluminescent Devices Comprising Fluorescent Dopants

50 mg PVK, 20 mg PBD, and 0.15 mg [3-(2-benzothiazolyl)-7-(diethylamino)coumarin (C6, Aldrich Chemical Co.) were dissolved in 3.6 ml chloroform to form a solution that was used to prepare Comparative Example K. 30 mg PVK, 20 mg MTDATA, 20 mg PBD, and 0.15 mg C6 were dissolved in 3.6 ml chloroform to form a solution that was used to prepare Example 16. 50 mg PVK, 20 mg PBD, and 0.15 mg Pyromethene 567 (Pyr567, Exciton Inc., Dayton, Ohio) were dissolved in 3.6 ml chloroform to form a solution that was used to prepare Comparative Example L. 25 mg PVK, 20 mg MTDATA, 20 mg PBD, and 0.15 mg C6 were dissolved in 3.6 ml chloroform to form a solution which was used to prepare Example 17. The solutions were spin-coated onto ITO/PEDT 4083 substrates prepared essentially as described in Comparative Example B. Devices of Comparative Example K and Example 16 were fabricated essentially as described in Comparative Example B.

Device performance and lifetimes of Comparative Examples K and L and Examples 16 and 17 are summarized in Table 1. MTDATA-containing devices (Examples 16 and 17) show significantly improved operation lifetimes in the range of 500-750 hours at a current density of 1.7 mA/cm2, whereas compositions of Comparative Examples K and L demonstrated only 1-4 hour lifetimes. This indicates that the organic electroluminescent compositions of the invention lead to increased electroluminescence lifetime independent of which emissive dopant is used.

### Examples 18-19

### MDP Electroluminescent Devices Comprising Electron Transport Materials OPOB and BND

15 mg PVK, 10 mg MTDATA, 10 mg OPOB, and 2 mg BTPIr were dissolved in 1.8 ml chloroform and the resulting solution was used to prepare Example 18. 15 mg PVK, 10 mg MTDATA, 2,5-bis-(1-naphthyl)-1,3,4-oxadiazole (BND), available from Lancaster Synthesis, Windham, N.H., 2 mg and BTPIr were dissolved in 1.8 ml chloroform to form a solution which was used to prepare Example 19. The solutions were spin-coated onto ITO/PEDT 4083 substrates prepared essentially as described in Comparative Example B. The devices were fabricated essentially as described in Comparative Example B.

Device performance and lifetimes of Examples 18 and 19 are summarized in Table 1. Operation lifetime of Example 18 was determined to be about 500 hours under a current density of 1.7 mA/cm², which indicates that the organic electroluminescent compositions of the invention lead to improved operational stability of MDP devices comprising a variety of electron transporting components.

### Examples 20 and 21

### MDP Organic Electroluminescent Devices Comprising Hole Transport Materials NDP and TDAPTA

15 mg PVK, 10 mg TDAPTA, 10 mg PBD, and 2 mg BTPIr were dissolved in 1.8 ml chloroform and the resulting solution was used to prepare Example 20. 15 mg PVK, 10 mg N,N′-bis(3-methylphenyl)-N,N′-bis(phenyl) benzidine (NPD), 10 mg PBD, and 2 mg BTPIr were dissolved in 1.8 ml chloroform and the resulting solution was used to prepare Example 21. The solutions were spin-coated onto ITO/PEDT 4083 substrates prepared essentially as described in Comparative Example B. Devices of Examples 20 and 21 were fabricated essentially as described in Comparative Example B.

Device performance and lifetimes of Examples 20 and 21 are summarized in Table 1. Operational lifetimes of the devices fall into 400-600 hour range at a current density of ca. 1.7 mA/cm² indicating that these tertiary aromatic amines can also be used as added hole-transport agents in MDP device formulations to achieve improvements in device operation stability.

### Examples 22-24

### MDP Organic Electroluminescent Devices with Varied Thickness of the MDP Layer

This example describes initial electroluminescence performance and operation lifetimes of spin-coated MDP devices where the thickness of the emitting layer has been varied.

The following stock solutions were prepared and blended in the proper combinations to prepare spin coated emitting layers for Examples 22-26:

MTDATA: (4,4′,4″-tris(N-(3-methylphenyl)-N-phenylamino)triphenylamine) (OSA 3939, H. W. Sands Corp., Jupiter, Fla.) 1.0% (w/w) in chloroform, filtered and dispensed through a Whatman Puradisc™ 0.45 μm Polypropylene (PP) syringe filter.

PVK: Poly(9-vinylcarbazole) (Aldrich Chemical Co., Milwaukee, Wis.) 1.0% (w/w) in chloroform, filtered and dispensed through a Whatman Puradisc™ 0.45 μm Polypropylene (PP) syringe filter.

PBD: 2-(4-biphenylyl)-5-(4-tert-butylphenyl)-1,3,4-oxadiazole (Dojindo) 1.0% (w/w) in chloroform was filtered and dispensed through a Whatman Puradisc™ 0.45 μm Polypropylene (PP) syringe filter.

PPIr: Bis-(2-phenylpyridinato-N,C^{2′})iridium(III) acetylacetonate was prepared essentially according to the method described in J. Am. Chem. Soc., 123, 4304 (2001)) 0.25% (w/w) in chloroform was filtered and dispensed through a Whatman Puradisc™ 0.45 μm Polypropylene (PP) syringe filter.

BTPIr: Bis-(2-benzo[c]thienylpyridinato-N,C^{2′})iridium(III) acetylacetonate (was prepared essentially according to the method described in J. Am. Chem. Soc., 123, 4304 (2001)). 0.25% (w/w) in chloroform was filtered and dispensed through a Whatman Puradisc™ 0.45 μm Polypropylene (PP) syringe filter.

Receptor substrates were prepared as follows: ITO(indium tin oxide) glass (Delta Technologies, Stillwater, Minn., less than 20 ohms/square, 1.1 mm thick) which was patterned using photolithography, was ultrasonically cleaned in a hot, 3% solution of Deconex™ 12NS detergent (Borer Chemie AG, Zuchwil, Switzerland). The substrates were then placed in the Plasma Science PS 500 (Plasma Science, Billerca, Mass.) high radio frequency plasma treater at 500 watts (165 W/cm²) power with an oxygen flow of 100 sccm for 2 minutes. Immediately after plasma treatment, a solution of PEDT CH-8000 was spin coated onto the receptor. PEDT CH-8000(poly(3,4-ethylenedioxythiophene/poly(styrenesulfonic acid)) solution (CH-8000 from Bayer A G, Leverkusen, Germany, diluted 1:1 with deionized water) was filtered through a Whatman Puradisc™ 0.45 μm polypropylene (PP) syringe filter and dispensed onto the ITO receptor substrate. The receptor substrate was then spun (Headway Research spincoater) at 2000 rpm for 30 s yielding a PEDT CH-8000 film thickness of 40 nm. All of the substrates were heated to 200° C. for 5 minutes under nitrogen. The compositions were spin coated onto the PEDT CH-8000 at different speeds, resulting in samples with 65, 75, and 95 nm in thickness, to form the devices of Examples 22-24 respectively. The device was completed by vacuum depositing in sequence 200 Å Alq, 7 Å LiF, 40 Å Al and 4000 Å Ag. Results are shown in Table 2.

### Examples 25 and 26

### MDP Compositions with Varied Concentrations of the Emitter

This example describes initial electroluminescence performance and operation lifetimes of spin-coated MDP devices in which the concentration of the emissive dopant in the MDP layer was varied. OLED devices were prepared using essentially the same method described in Examples 22-24 except that the compositions spun coat onto PEDT CH-8000 were formulated as shown in Examples 25 and 26 of Table 1. Results are shown in Table 2.

### Comparative Example M and Examples 27 and 28

### MF Organic Electroluminescent Devices Comprising Phosphorescent Iridium Emitter

This example compares MF devices comprising TPD, PBD, PPIr versus those based on MTDATA, TPD, PBD, and PPIr. ITO substrates were prepared essentially according to Comparative Example A. PEDT 4083 was spin-coated onto the slides at 2500 RPM and annealed as in that same example. The following solutions were prepared: a) 0.0397 g TPD, 0.0638 g PBD, 0.0021 g PPIr, 5.18 g CHCl₃ (about 2 wt % solids); b) 0.0336 g TPD, 0.1078 g PBD, 0.0040 g PPIr, 0.0540 g MTDATA, 9.77 g CHCl₃; c) 0.0370 g MTDATA, 0.010 g TPD, 0.053 g PBD, 0.004 g PPIr, 5.0 g CHCl₃. Solutions a) and b) were spun coated onto ITO/PEDT 4083 slides at 4500 RPM. Solution c) was spun coat onto ITO/PEDT 4083 slides at 3500 RPM. A cathode consisting of 7 Å of LiF and 2000 Å of aluminum was deposited as described in Comparative Examples A and B. Molecular film compositions (weight fractions), performance and reliability data for the three sets of devices are shown in Table 3.

The lifetime of the device of Example M was limited to about 5 hrs. Addition of MTDATA to the MF resulted in a decrease in the device efficiencies and brightness (Examples 27 and 28. However these devices exhibited significantly improved lifetimes.

### Example 29

### Preparation of a Donor Sheet Without a Transfer Layer

A light-to-heat conversion (LTHC) solution was prepared by mixing 3.55 parts carbon black pigment (Raven™ 760 Ultra Columbian Chemical Co., Atlanta, Ga.), 0.63 parts polyvinyl butyral resin (Butvar™ B-98, Solutia Inc., St. Louis, Mo.), 1.90 parts acrylic resin (Joncryl™ 67, S. C. Johnson & Sons, Inc., Racine, Wis.), 0.32 parts dispersant (Disperbyk™ 161, Byk-Chemie USA, Wallingford, Conn.), 0.09 parts fluorochemical surfactant as taught, for example, in Example 5 of U.S. Pat. No. 3,787,351, 12.09 parts epoxynovolac acrylate (Ebecryl™ 629, UCB Radcure Inc., N. Augusta, S.C.), 8.06 parts acrylic resin (Elvacite™ 2669, ICI Acrylics Inc., Memphis, Tenn.), 0.82 parts 2-benzyl-2-(dimethylamino)-1-(4-(morpholinyl)phenyl) butanone (Irgacure™ 369, Ciba-Geigy Corporation, Tarrytown, N.Y.), 0.12 parts 1-hydroxycyclohexyl phenyl ketone (Irgacure™ 184, Ciba-Geigy), 45.31 parts 2-butanone and 27.19 parts 1,2-propanediol monomethyl ether acetate. This solution was coated onto a 0.1 mm thick polyethylene terephthalate (PET) film substrate (M7 from Teijin, Osaka, Japan). Coating was performed using a Yasui Seiki Lab Coater, Model CAG-150, using a microgravure roll with 150 helical cells per inch. The LTHC coating was in-line dried at 80° C. and cured under ultraviolet (UV) radiation. A Fusion 600 Watt D bulb at 100% energy (UVA 320 to 390 nm)output was used to supply the radiation. Exposure was at 6.1 m/min.

Next, an interlayer solution was made by mixing 14.85 parts trimethylolpropane triacrylate ester (SR 351HP, available from Sartomer, Exton, Pa.), 0.93 parts Butvar™ B-98, 2.78 parts Joncryl™ 67, 1.25 parts Irgacure™ 369, 0.19 parts Irgacure™ 184, 48 parts 2-butanone and 32 parts 1-methoxy-2-propanol. This solution was coated onto the cured LTHC layer by a rotogravure coating method using the Yasui Seiki lab coater, Model CAG-150, with a microgravure roll having 180 helical cells per lineal inch. This coating was in-line dried at 60° C. and cured under ultraviolet (UV) radiation. Curing was performed by passing the coating under a Fusion 600 Watt D bulb at 60% energy output.

Preparation of Solutions for Receptor

PEDT CH-8000 was prepared as described in Examples 22-24.

Preparation of Receptor Substrates

Receptor substrates were prepared as described in Examples 22-24.

Preparation of Solutions for Transfer Layer

The following stock solutions were prepared:

MTDATA: (4,4′,4″-tris(N-(3-methylphenyl)-N-phenylamino)triphenylamine) (OSA 3939, H. W. Sands Corp., Jupiter, Fla.) 2.5% (w/w) in 1,2 dichloroethane and 2.5%(w/w) in toluene, filtered and dispensed through a Whatman Puradisc™ 0.45 μm Polypropylene (PP) syringe filter.

PVK: Poly(9-vinylcarbazole) (Aldrich Chemical Co., Milwaukee, Wis.) 2.5% (w/w) in 1,2 dichloroethane and 2.5%(w/w) in toluene, filtered and dispensed through a Whatman Puradisc™ 0.45 μm Polypropylene (PP) syringe filter. Solution of ODP3: 0.5% (w/w) in toluene was made, filtered, and dispensed through a Whatman Puradisc™ 0.45 μm Polypropylene (PP) syringe filter.

PBD: 2-(4-biphenylyl)-5-(4-tert-butylphenyl)-1,3,4-oxadiazole (Dojindo) 2.5% (w/w) in 1,2 dichloroethane and 2.5%(w/w) in toluene was filtered and dispensed through a Whatman Puradisc™ 0.45 μm Polypropylene (PP) syringe filter.

PPIr: Bis-(2-phenylpyridinato-N,C^{2′})iridium(III) acetylacetonate was prepared according to the method described in J. Am. Chem. Soc., 123, 4304 (2001)) 0.25% (w/w) in 1,2 dichloroethane was filtered and dispensed through a Whatman Puradisc™ 0.45 μm Polypropylene (PP) syringe filter.

BTPIr: Bis(2-benzo[c]thienylpyridinato-N,C^{2′})iridium(III) acetylacetonate (was prepared according to the method described in J. Am. Chem. Soc., 123, 4304 (2001). 0.25% (w/w) in 1,2 dichloroethane was filtered and dispensed through a Whatman Puradisc™ 0.45 μm Polypropylene (PP) syringe filter.

5TFM PPIr: Bis(2-(5′-trifluoromethylphenyl)pyridinato-N,C^{2′})iridium(III) acetylacetonate was prepared essentially according to the method above. 0.25% (w/w) in toluene was filtered and dispensed through a Whatman Puradisc™ 0.45 μm Polypropylene (PP) syringe filter.

### Comparative Examples N and O and Examples 30-34

### Preparation of Transfer Layers on Donor Sheet and Transfer of Transfer Layers

Transfer layers were formed on the donor sheets of Example 29 using the compositions outlined in Table 4. To obtain the blends, the solutions prepared for the transfer layer were mixed at the appropriate ratios and the resulting blend solutions were stirred for 20 min at room temperature. The transfer layers were deposited on the donor sheets by spinning (Headway Research spincoater) at about 2000-2500 rpm for 30 s to yield a film thickness of approximately 100 nm.

Donor sheets coated as described above were brought into contact with receptor substrates essentially as described in Examples 22-24, with the exception that the substrates were unpatterned ITO-coated glass. Next, the donors were imaged using two single-mode Nd:YAG lasers. Scanning was performed using a system of linear galvanometers, with the combined laser beams focused onto the image plane using an f-theta scan lens as part of a near-telecentric configuration. The laser energy density was 0.4 to 0.8 J/cm². The laser spot size, measured at the 1/e² intensity, was 30 micrometers by 350 micrometers. The linear laser spot velocity was adjustable between 10 and 30 meters per second, measured at the image plane. The laser spot was dithered perpendicular to the major displacement direction with about a 100 μm amplitude. The transfer layers were transferred as lines onto the receptor substrates, and the intended width of the lines was about 100 μm.

The transfer layers were transferred in a series of lines. The results of imaging are given in Table 4, wherein “good imaging” is when the material transfers within 10% of the requested line width and the entire thickness of material, with edge roughness less than 5 microns, and with a minimal number of voids and surface defects.

### Comparative Example P and Example 35

### Preparation of Laser Induced Thermal Imaging (LITI) Fabricated Organic Luminescent Devices

MDP layers with compositions listed in Table 5 were LITI patterned onto receptions essentially as in Examples 22-24. LITI patterning was conducted at fixed laser energy of 0.55 J/cm². The transfer layers were transferred in a series of lines that were in overlaying registry with the ITO stripes on the receptor. An electron transport layer, Alq, followed by a LiF/Al/Ag cathode, was deposited onto the patterned MDP layer as described in Examples 22-24 to form the LITI devices of Comparative Example P and Example 35. The device results are shown in Table 5. In both cases, green light was emitted from the devices.

TABLE 1

| | | Voltage at | Peak | | |
|---|---|---|---|---|---|
| Example | | 4 mA/cm² | Efficiency | Operation Half Life (hours), | |
| No. | Device structure | (V) | (Cd/A) | J (mA/cm²) and L (Cd/m²) | |
| A | ITO/PEDT 4083/PVK(0.66):PBD(0.27):PPIr/LiF/Al | 12.5 ± 1.5 | 30 ± 5 | <10 | (1.6, 500 ± 100) |
| B | ITO/PEDT 4083/PVK(0.66):PBD(0.27):PPIr/Alq/LiF/Al | 13 ± 2 | 30 ± 5 | <10 | (1.7, 500 ± 100) |
| C | ITO/PEDT 4083/PVK(0.66):PBD(0.27):BTPIr/LiF/Al | 14 ± 2 | 3 ± 0.5 | <10 | (1.7, 65 ± 10) |
| D | ITO/PEDT 4083/PVK(0.66):PBD(0.27):BTPIr/Alq/LiF/Al | 14 ± 2 | 4 ± 0.5 | <10 | (1.6, 75 ± 10) |
| E | ITO/PEDT 4083/PVK(0.41):CBP(0.26):PBD(0.26):PPIr/Alq/LiF/Al | 12.5 ± 1 | 20 ± 4 | <10 | (1.5, 400 ± 80) |
| F | ITO/PEDT 4083/PVK(0.41):TPD(0.26):PBD(0.26):PPIr/Alq/LiF/Al | 11 ± 1 | 4 ± 1 | 30 | (1.6, 60 ± 10) |
| 1 | ITO/PEDT 4083/PVK(0.41):MTDATA(0.26):PBD(0.26):PPIr/LiF/Al | 8 ± 1 | 2.8 ± 0.5 | 0.5 × 10³ | (1.6, 45 ± 10) |
| 2 | ITO/PEDT | 7.5 ± 1 | 11 ± 1 | 1 × 10³ | (1.7, 120 ± 20) |
| | 4083/PVK(0.41):MTDATA(0.26):PBD(0.26):PPIr/Alq/LiF/Al | | | | |
| 3 | ITO/PEDT 4083/PVK(0.41):MTDATA(0.26):PBD(0.26):BTPIr/LiF/Al | 8.5 ± 1 | 1 ± 0.2 | 0.5 × 10³ | (1.7, 10 ± 4) |
| 4 | ITO/PEDT | 8 ± 1 | 2.5 ± 0.5 | 1-2 × 10³ | (1.7, 30 ± 8) |
| | 4083/PVK(0.41):MTDATA(0.26):PBD(0.26):BTPIr/Alq/LiF/Al | | | | |
| G | ITO/PEDT 4083/PVK-DPAS(0.67):PBD(0.26):PPIr/Alq/LiF/Al | 15 ± 1 | 26 ± 5 | 0.8 | (1.6, 150 ± 15) |
| 5 | ITO/PEDT 4083/PVK- | 10 ± 1 | 3.5 ± 0.5 | 60 | (1.6, 60 ± 5) |
| | DPAS(0.41):MTDATA(0.26):PBD(0.26):PPIr/Alq/LiF/Al | | | | |
| H | ITO/PEDT 4083/PVK-DPAS(0.67):PBD(0.26):BTPIr/Alq/LiF/Al | 15 ± 1 | 4 ± 0.5 | 1.2 | (1.6, 75 ± 15) |
| 6 | ITO/PEDT 4083/PVK- | 11 ± 1.5 | 1 ± 0.2 | 200 | (1.7, 15 ± 3) |
| | DPAS(0.41):MTDATA(0.26):PBD(0.26):BTPIr/Alq/LiF/Al | | | | |
| 7 | ITO/PEDT | 7.7 ± 0.5 | 1.6 ± 0.3 | 280 | (1.6, 10 ± 2) |
| | 4083/PS(0.26):MTDATA(0.41):PBD(0.26):BTPIr/Alq/LiF/Al | | | | |
| 8 | ITO/PEDT | 9.2 ± 1 | 3.2 ± 0.5 | 180 | (1.6, 35 ± 10) |
| | 4083/PS(0.41):MTDATA(0.26):PBD(0.26):BTPIr/Alq/LiF/Al | | | | |
| I | ITO/PEDT 4083/PS(0.26):TCTA(0.41):PBD(0.26):BTPIr/Alq/LiF/Al | 9.3 ± 0.5 | 3.7 ± 0.5 | 7 | (1.6, 70 ± 15) |
| 9 | ITO/PEDT 4083/ODP1(0.69):MTDATA(0.26):BTPIr/Alq/LiF/Al | 10.6 ± 0.5 | 2.7 ± 0.4 | — | |
| 10 | ITO/PEDT 4083/ODP1(0.55):MTDATA(0.40):BTPIr/Alq/LiF/Al | 8.8 ± 0.3 | 2.0 ± 0.3 | 0.5 × 10³ | (1.7, 27 ± 3) |
| 11 | ITO/PEDT 4083/ODP1(0.40):MTDATA(0.55):BTPIr/Alq/LiF/Al | 7.1 ± 0.4 | 1.75 ± 0.3 | 0.7 × 10³ | (1.7, 15 ± 3) |
| 12 | ITO/PEDT 4083/ODP1(0.26):MTDATA(0.69):BTPIr/Alq/LiF/Al | 7.1 ± 0.3 | 1.5 ± 0.3 | 0.65 × 10³ | (1.7, 10 ± 3) |
| J | ITO/PEDT 4083/ODP2(0.60):CBP(0.36):PPIr/Alq/LiF/Al | 15.6 ± 0.9 | 19.5 ± 4.5 | 1 | (1.7, 320 ± 40) |
| 13 | ITO/PEDT | 9.8 ± 0.3 | 4.6 ± 1.1 | 90 | (1.7, 50 ± 10) |
| | 4083/ODP2(0.60):CBP(0.18):MTDATA(0.18):PPIr/Alq/LiF/Al | | | | |
| 14 | ITO/PEDT 4083/PVK(0.41):MTDATA(0.26):PBD(0.27):PtOEP/LiF/Al | 9.6 ± 0.3 | 0.2 ± 0.05 | 0.6 × 10³ | (1.7, 5 ± 1) |
| 15 | ITO/PEDT | 9.6 ± 0.4 | 0.75 ± 0.1 | 0.7 × 10³ | (1.7, 18 ± 3) |
| | 4083/PVK(0.41):MTDATA(0.26):PBD(0.27):PtOEP/Alq/LiF/Al | | | | |
| K | ITO/PEDT 4083/PVK(0.713):PBD(0.285):C6/Alq/LiF/Al | 9.8 ± 0.4 | 4.0 ± 0.45 | 1 | (1.7, 70 ± 6) |
| 16 | ITO/PEDT | 8.2 ± 0.2 | 1.3 ± 0.19 | 0.75 × 10³ | (1.7, 20 ± 3) |
| | 4083/PVK(0.428):MTDATA(0.285):PBD(0.285):C6/Alq/LiF/Al | | | | |
| L | ITO/PEDT 4083/PVK(0.713):PBD(0.285):Pyr567/Alq/LiF/Al | 11.5 ± 0.5 | 6.8 ± 0.8 | 4 | (1.7, 110 ± 10) |
| 17 | ITO/PEDT | 9.5 ± 0.3 | 1.8 ± 0.15 | 0.5 × 10³ | (1.7, 25 ± 4) |
| | 4083/PVK(0.428):MTDATA(0.285):PBD(0.285):Pyr567/Alq/LiF/Al | | | | |
| 18 | ITO/PEDT | 9.5 ± 0.4 | 0.9 ± 0.2 | 0.5 × 10³ | (1.7, 15 ± 2) |
| | 4083/PVK(0.41):MTDATA(0.26):OPOB(0.26):BTPIr/Alq/LiF/Al | | | | |
| 19 | ITO/PEDT | 8.7 ± 0.4 | 1.45 ± 0.3 | — | |
| | 4083/PVK(0.41):MTDATA(0.26):BND(0.26):BTPIr/Alq/LiF/Al | | | | |
| 20 | ITO/PEDT | 8.0 ± 0.4 | 0.7 ± 0.1 | 0.6 × 10³ | (1.7, 10 ± 2) |
| | 4083/PVK(0.41):TDAPTA(0.26):PBD(0.26):BTPIr/Alq/LiF/Al | | | | |
| 21 | ITO/PEDT 4083/PVK(0.41):NPD(0.26):PBD(0.26):BTPIr/Alq/LiF/Al | 8.1 ± 0.3 | 1.5 ± 0.2 | 0.4 × 10³ | (1.7, 22 ± 2) |

TABLE 2

| | | | | | Operation |
|---|---|---|---|---|---|
| | | | | | Half Life |
| Ex- | | MDP Layer | Voltage at | Peak | (hours), |
| ample | | Thickness | 4mA/cm² | Efficiency | J (mA/cm²) |
| No. | Device Structure | (nm) | (V) | (Cd/A) | and L (Cd/m²) |
| 22 | ITO/PEDT CH- | 60 | 6.8 | 9.5 +/−0.3 | 100 (5, 250) |
| | 8000/PVK(0.42):MTDATA(0.28):PBD(0.27):PPIr(0.03)/LiF/AL/Ag | | | | |
| 23 | ITO/PEDT CH- | 75 | 7.7 | 8.4 +/−0.2 | 70 (6.6, 250) |
| | 8000/PVK(0.42):MTDATA(0.28):PBD(0.27):PPIr(0.03)/LiF/Al/Ag | | | | |
| 24 | ITO/PEDT CH- | 95 | 10.3 | 6.3 +/−0.5 | 50 (4.6, 250) |
| | 8000/PVK(0.42):MTDATA(0.28):PBD(0.27):PPIr(0.03)/LiF/Al/Ag | | | | |
| 25 | ITO/PEDT CH- | 62 | 7.2 | 1.2 +/−0.1 | 400 (5.1, 50) |
| | 8000/PVK(0.42):MTDATA(0.28):PBD(0.27):BtPIr(0.03) | | | | |
| | /LiF/Al/Ag | | | | |
| 26 | ITO/PEDT CH- | 65 | 7 | 1.15 +/− 0.1 | 650 (4.3, 50) |
| | 8000/PVK(0.41):MTDATA(0.27):PBD(0.26):BtPIr(0.06) | | | | |
| | /LiF/Al/Ag | | | | |

TABLE 3

| | | Voltage at | | Peak | Operation Half Life |
|---|---|---|---|---|---|
| Example | | 4mA/cm² | Peak Ext. | Efficiency | (hours), J (mA/cm²) |
| No. | Device Structure | (V) | QE (%) | (Cd/A) | and L (Cd/m²) |
| M | ITO/PEDT 4083/TPD(.38):PBD(0.6)PPIr/LiF/Al | 8.0 | 6.3 | 23 | 5.1 (3.8, 737) |
| 27 | ITO/PEDT 4083/TPD(0.17):MTDATA(0.27)PBD(0.54) PPIr/LiF/Al | 9.4 | 3.3 | 12 | 36(3.8,481) |
| 28 | ITO/PEDT 4083/TPD(0.1):MTDATA(0.36):PBD(0.51)PPIr/LiF/Al | 9.97 | 1.32 | 4.8 | 117(3.8,162) |

TABLE 4

| Example | | Solvent for Transfer | Transfer System | | |
|---|---|---|---|---|---|
| Number | Transfer System | System | Composition (w %) | Receptor System | Result of Dosing |
| N | PVK:PBD:PPIr | 1, 2 dichloroethane | 69:28:3 | PEDT CH-8000 | good imaging |
| 30 | PVK:MTDATA:PBD:PPIr | 1, 2 dichloroethane | 60:10:27:3 | PEDT CH-8000 | good imaging |
| 31 | PVK:MTDATA:PBD:PPIr | 1, 2 dichloroethane | 50:20:27:3 | PEDT CH-8000 | good imaging |
| 32 | PVK:MTDATA:PBD:PPIr | 1, 2 dichloroethane | 42:28:27:3 | PEDT CH-8000 | good imaging |
| O | PVK:PBD:BtPIr | 1, 2 dichloroethane | 69:28:3 | PEDT CH-8000 | good imaging |
| 33 | ODP3:MTDATA | Toluene | 50:50 | PEDT CH-8000 | good imaging |
| 34 | MTDATA:TPD:PBD:5TFM PPIr | Toluene | 36:9:51:4 | PEDT CH-8000 | good imaging |

TABLE 5

| Example | | | Voltage (V) | Efficiency (Cd/A) |
|---|---|---|---|---|
| Number | LITI Transfer System | Composition (wt %) | at 500 Cd/m² | at 500 Cd/m² |
| P | ITO/PEDT CH- | 69:28:3 | 12.5 | 18 |
| | 8000/PVK:PBD:PPIr/Alq/LiF/Al/Ag | | | |
| 35 | ITO/PEDT CH- | 42:28:27:3 | 14 | 5.5 |
| | 8000/PVK:MTDATA:PBD:PPIr/Alq/LiF/Al/Ag | | | |

The complete disclosures of the publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

What is claimed is:

1. An organic electroluminescent composition comprising
(a) a charge transport matrix comprising at least one electron transport material;
(b) at least one non-polymeric emissive dopant; and
(c) at least one tertiary aromatic amine comprising three organic groups directly bonded to nitrogen, said tertiary aromatic amine being selected from the group consisting of
(1) tertiary aromatic amines wherein at least one said organic group comprises a substituted phenyl group having an electron-donating substituent in the para-position or two independently selected electron-donating substituents in the meta-positions, each said electron-donating substituent being a substituent other than a heterocyclic substituent directly bonded to said phenyl group by one of its heteroatoms,
(2) tertiary aromatic amines wherein at least two said organic groups each comprise an independently selected substituted biphenyl or substituted fluorenyl group having an electron-donating substituent in the para-position of its terminal phenyl ring, and
(3) tertiary aromatic amines wherein at least one said organic group comprises a fused polyaromatic group and at least one other said organic group comprises a substituted biphenyl or substituted fluorenyl group having an electron-donating substituent in the para-position of its terminal phenyl ring;
said tertiary aromatic amines of categories (1), (2), and (3) being optionally further substituted, but only with electron-donating substituents;
with the proviso that when said charge transport matrix consists essentially of an electron transport material that is non-polymeric, said tertiary aromatic amine is selected from amines other than non-polymeric amines of category (3); and
with the further proviso that when said charge transport matrix contains a polyimide, said charge transport matrix comprises a second polymeric material other than a polyimide.

2. The composition of claim 1 wherein said non-polymeric emissive dopant is phosphorescent.

3. The composition of claim 1 wherein said electron transport material is selected from the group consisting of 2-(4-biphenyl)-5-(4-t-butylphenyl)-1,3,4-oxadiazole, 1,3,5-tris(5-(p-octyloxyphenyl)-1,3,4-oxadiazol-2-yl)benzene, 3-(4-biphenylyl)-4-phenyl-5-(4-tert-butylphenyl)1,2,4-triazole, and oxadiazole-containing and triazole-containing polymers.

4. The composition of claim 1 wherein said charge transport matrix further comprises one or more hole transport materials or electrically inert materials.

5. The composition of claim 1 wherein said tertiary aromatic amine is represented by one of the following general formulas: 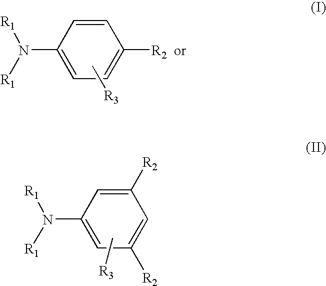
wherein each R₁ is independently selected from the group consisting of alkyl, cycloalkyl, alkenyl, cycloalkenyl, alkynyl, cycloalkynyl, aryl, heteroaryl, and combinations thereof; each R₂ is independently selected from the group consisting of alkoxy, aryloxy, alkylthio, arylthio, dialkylamino, diarylamino, and combinations thereof; and each R₃ is independently selected from the group consisting of hydrogen, alkyl, cycloalkyl, alkenyl, cycloalkenyl, alkynyl, cycloalkynyl, aryl, and combinations thereof.

6. The composition of claim 5 wherein each R₁ is an independently selected aryl; each R₂ is an independently selected diarylamino; and each R₃ is independently selected from the group consisting of hydrogen and alkyl.

7. The composition of 6 wherein each R₁ is independently selected from the group consisting of phenyl and m-tolyl; each R₂ is independently selected from the group consisting of diphenylamino, N-phenyl-N-(3-methylphenyl)amino, and di(p-t-butylphenyl)amino; and each R₃ is independently selected from the group consisting of hydrogen, methyl, n-butyl, and t-butyl.

8. The composition of claim 5 wherein said three organic groups directly bonded to nitrogen are identical.

9. The composition of claim 1 wherein said tertiary aromatic amine is represented by one of the following general formulas: 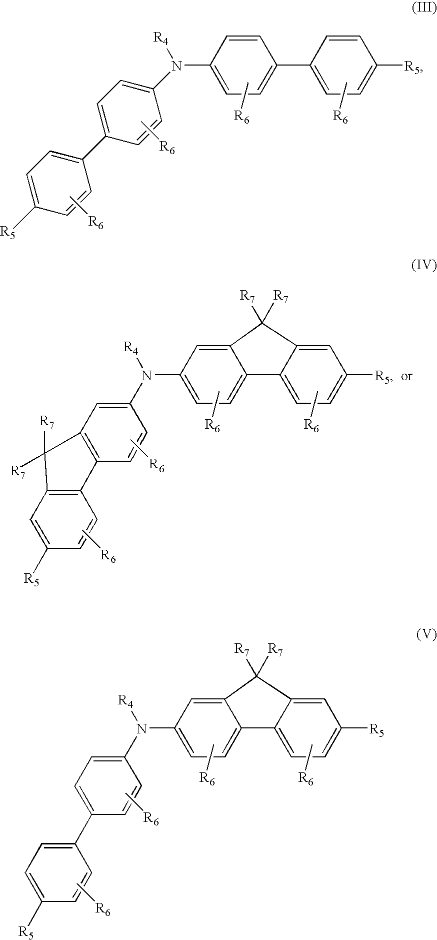
wherein each R₄ is independently selected from the group consisting of alkyl, cycloalkyl, alkenyl, cycloalkenyl, alkynyl, cycloalkynyl, aryl, heteroaryl, and combinations thereof; each said R₅ is independently selected from the group consisting of alkoxy, aryloxy, alkylthio, arylthio, dialkylamino, diarylamino, and combinations thereof; each R₆ is independently selected from the group consisting of hydrogen, alkyl, cycloalkyl, alkenyl, cycloalkenyl, alkynyl, cycloalkynyl, aryl, and combinations thereof; and each R₇ is independently selected from the group consisting of hydrogen, alkyl, cycloalkyl, alkenyl, cycloalkenyl, alkynyl, cycloalkynyl, aryl, and combinations thereof.

10. The composition of claim 9 wherein each R₄ is an independently selected aryl; each said R₅ is an independently selected diarylamino; each R₆ is independently selected from the group consisting of hydrogen and alkyl; and each R₇ is independently selected from the group consisting of hydrogen and alkyl.

11. The composition of claim 10 wherein each R₄ is independently selected from the group consisting of phenyl and m-tolyl; each R₅ is independently selected from the group consisting of diphenylamino, N-phenyl-N-(3-methylphenyl)amino, and di(p-t-butylphenyl)amino; each R₆ is independently selected from the group consisting of hydrogen, methyl, n-butyl, and t-butyl; and each R₇ is independently selected from the group consisting of hydrogen, methyl, n-butyl, and octyl.

12. The composition of claim 9 wherein said three organic groups directly bonded to nitrogen are identical.

13. The composition of claim 1 wherein said tertiary aromatic amine is represented by one of the following general formulas: 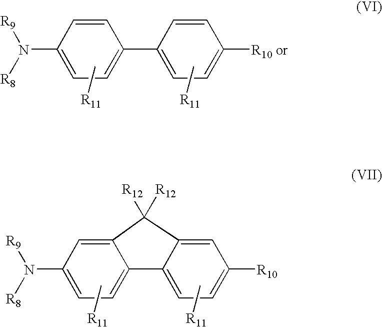
wherein each R₈ is a fused polyaromatic group; each R₉ is independently selected from the group consisting of alkyl, cycloalkyl, alkenyl, cycloalkenyl, alkynyl, cycloalkynyl, aryl, heteroaryl, fused polyaromatics, and combinations thereof; each R₁₀ is independently selected from the group consisting of alkoxy, aryloxy, alkylthio, arylthio, dialkylamino, diarylamino, and combinations thereof; each R₁₁ is independently selected from the group consisting of hydrogen, alkyl, cycloalkyl, alkenyl, cycloalkenyl, alkynyl, cycloalkynyl, aryl, heteroaryl, and combinations thereof; and each R₁₂ is independently selected from the group consisting of hydrogen, alkyl, cycloalkyl, alkenyl, cycloalkenyl, alkynyl, cycloalkynyl, aryl, heteroaryl, and combinations thereof.

14. The composition of claim 13 wherein each R₈ is selected from the group consisting of naphthyl, anthracenyl, pyrenyl, and phenanthrenyl; each R₉ is independently selected from the group consisting of aryl and fused polyaromatics; each R₁₀ is an independently selected diarylamino group; each R₁₁ is independently selected from the group consisting of hydrogen and alkyl; and each R₁₂ is independently selected from the group consisting of hydrogen and alkyl.

15. The composition of claim 14 wherein each R₈ is independently selected from the group consisting of naphthyl, anthracenyl, and phenanthrenyl; each R9 is independently selected from the group consisting of phenyl, m-tolyl, and naphthyl each R₁₀ is independently selected from the group consisting of diphenylamino, N-phenyl-N-(2-naphthyl)amino, N-(3-methylphenyl)-N-(2-naphthyl)amino, N-phenyl-N-(3-methylphenyl)amino, and di(p-t-butylphenyl)amino; each R₁₁ is independently selected from the group consisting of hydrogen, methyl, and n-butyl; and each R₁₂ is independently selected from the group consisting of hydrogen, methyl, n-butyl, and octyl.

16. The composition of claim 13 wherein R₈ and R₉ are identical fused polyaromatic groups.

17. The composition of claim 1 wherein said tertiary aromatic amine is chosen from the group consisting of

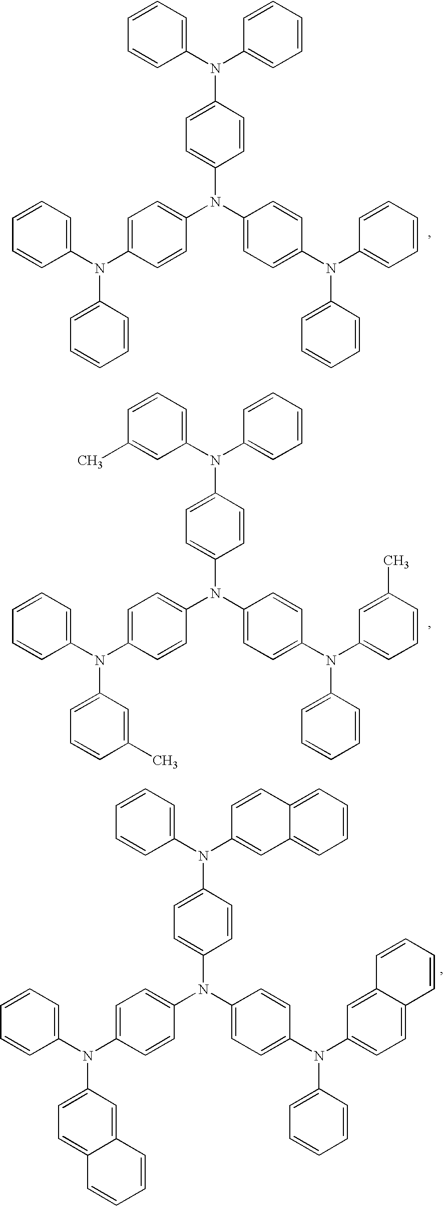

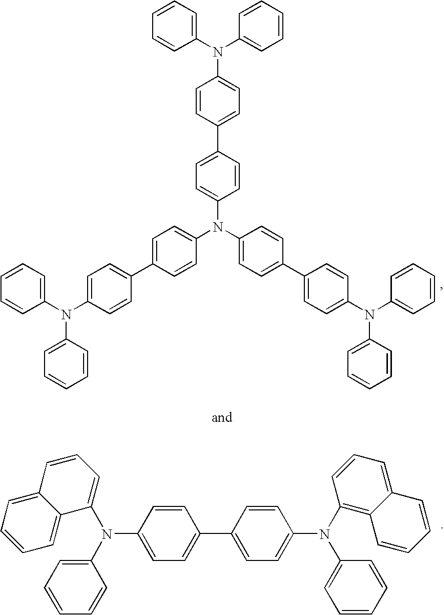

18. The composition of claim 1 wherein said charge transport matrix does not contain polyimide.

19. An organic electroluminescent composition comprising
(a) a charge transport matrix comprising an electron transport material selected from the group consisting of 2-(4-biphenyl)-5-(4-t-butylphenyl)-1,3,4-oxadiazole, 1,3,5-tris(5-(p-octyloxyphenyl)-1,3,4-oxadiazol-2-yl)benzene, 3-(4-biphenylyl)-4-phenyl-5-(4-tert-butylphenyl)1,2,4-triazole, and oxadiazole-containing and triazole-containing polymers;
(b) at least one non-polymeric emissive dopant; and
(c) at least one tertiary aromatic amine chosen from the group consisting of

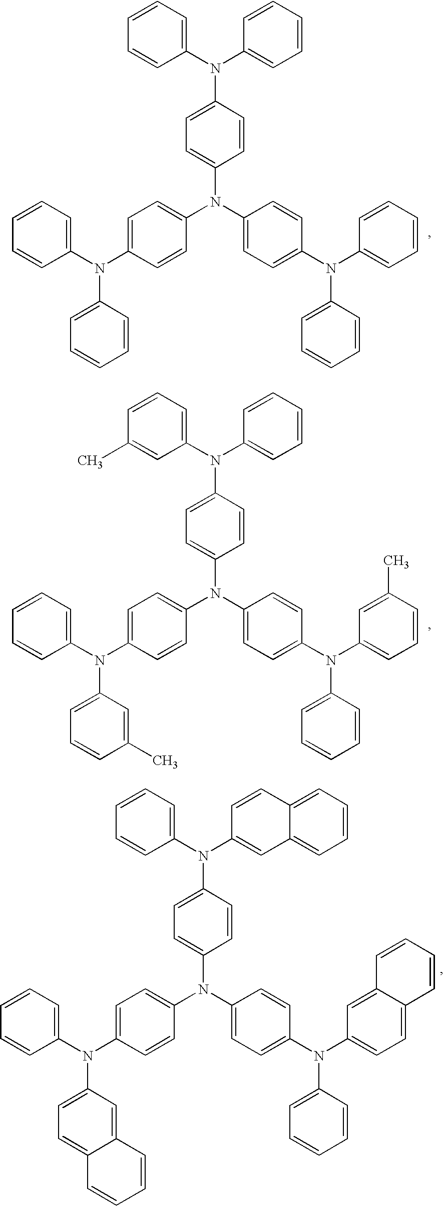

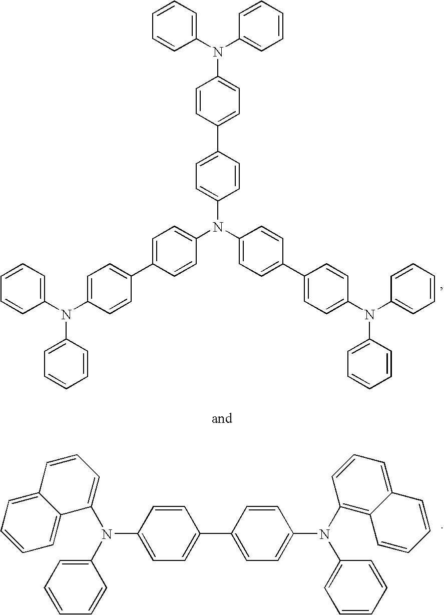

20. The composition of claim 19 wherein said charge transport matrix further comprises one or more hole transport materials or electrically inert materials.

21. The composition of claim 19 wherein said non-polymeric emissive dopant is phosphorescent.

22. An organic electroluminescent composition comprising
(a) a charge transport matrix comprising at least one electron transport material;
(b) at least one non-polymeric emissive dopant; and
(c) at least one tertiary aromatic amine having a hole mobility greater than about 10⁻⁵ cm²/V s and an ionization potential between about 4.8 eV and about 5.4 eV.

23. An organic electroluminescent device comprising the composition of claim 1, claim 19, or claim 22.

24. The organic electroluminescent device of claim 23 wherein said device is an organic light-emitting diode.

25. An article comprising the organic electroluminescent device of claim 23 or the organic light-emitting diode of claim 24.

26. The article of claim 25 wherein said article is a display.

27. A method of making an organic electroluminescent device comprising the step of selectively transferring the composition of claim 1, claim 19, or claim 22 from a donor sheet to a receptor substrate.

28. A donor sheet comprising
(a) a substrate,
(b) a light-to-heat conversion layer, and
(c) a transfer layer comprising the composition of claim 1, claim 19, or claim 22.
